(19) United States
(12) Patent Application Publication
(10) Pub. No.: US 2005/0003801 A1
(43) Pub. Date: Jan. 6, 2005

(54) High speed mobile terminal data communications device, system, and method

(76) Inventors: Michael S. Randall, Cary, NC (US); Mary E. Randall, Cary, NC (US)

Correspondence Address: WITHROW & TERRANOVA, P.L.L.C., P.O. BOX 1287, CARY, NC, 27512, US

(21) Appl. No.: 10/606,718

(22) Filed: Jun. 26, 2003

(51) Int. Cl. H04B 7/00; H04Q 7/20

(52) U.S. Cl. 455/414.1; 455/517; 455/507

(57) ABSTRACT

An application server that establishes a peer-to-peer connection with a mobile terminal over a data packet network for the purpose of allowing the mobile terminal to request and receive data associated with the application server. In one embodiment, the mobile terminal is a cellular telephone, and the application server is a server that executes a real estate listings information retrieval program to allow the mobile terminal to request and receive real estate records in real time over a TCP/IP based network. The application server includes an application program that assigns a thread to each connection and assigns a state in a state-machine for each thread. The application program executes a state-machine for each thread based on the state of each thread in response to information requests from the mobile terminal.

### FIELD OF THE INVENTION

The present invention relates to an application server that establishes a peer-to-peer connection with a mobile terminal to provide real-time information in response to information requests by a mobile terminal, and in particular, for real estate and medical records.

### BACKGROUND OF THE INVENTION

Cellular telephones are commonly used today to establish telephony communications between a caller and a receiver. With the advancement of digital communications, cellular telephone providers have developed the additional ability for cellular telephones, or other mobile terminals that do not include telephony capability, to transmit data as well as voice information over a cellular telephone network. In the case of a cellular telephone, the cellular telephone communicates data by first establishing a call with a cellular telephone network. The cellular telephone network receives the call from the cellular telephone, and a public switch telephone network (PSTN) switch uses a gateway to convert the data into a data packet using an Internet protocol (IP). The data packet can then be communicated over the Internet via the cellular telephone network.

A common feature of the cellular phone network is to provide the ability of a cellular telephone to request web content from the Internet. The cellular telephone may include the IP address and a uniform resource locator (URL) address to direct the communication from the cellular telephone network to the addressed server to obtain web content from over the Internet. It is common for the cellular telephone to include a web browser so that web page content, typically in the form of the hypertext markup language (HTML), can be displayed on the cellular telephone's web browser display. The cellular telephone network via its coupling to the Internet, retrieves the web content and communicates such content back to the cellular telephone via the cellular telephone network.

One example of this information that may be communicated between a cellular telephone or other mobile terminal and a data packet network may be real estate listings. Real estate agents quite commonly need instant access to real estate listings while away from their office in the field to match a home buyer to a home with defined criteria. For example, the home buyer may want the real estate agent to show them all houses in a certain area that are between $200,000 and $225,000 with a two-car garage. If the real estate agent is not within easy access of a traditional personal computer connected to the Internet using a wired cable, the real estate agent will be able to provide this information to the home buyer in the field. Using a mobile communication terminal that has data transmission capability.

One problem with this system is that web page requests do not get fulfilled quickly. Even though the cellular telephone may include a processor capable of handling high speed communications, web page content access can be quite slow. One reason for this is that a web page content request is in the form of a large connectionless packet or HTML request to the cellular phone network. The cellular phone network passes the request out over the Internet to reach the addressed web content server at the designated IP address. Every request must stand on its own, meaning that the cellular telephone must send a large packet or HTML request for each web content request, including all of the overhead necessary to establish a new information request.

One solution that has been implemented to reduce the size of HTML requests is called “web clippings.” Web clippings are proprietary to PALM® computing devices. Web clippings take web content that is normally designed to be displayed on a desktop computer browser and reduce the size of the web content needed to fulfill the HTML request. For example, a request made by the cellular telephone to the MapQuest™ web site at www.mapquest.com for driving directions may only provide textual driving directions without the inclusion of banner and other graphical information.

However, even web clippings still suffer from low speed data transfers. The HTML requests fulfilled by web clippings are still transmitting both screen information and formatting instructions, albeit less than a standard HTML page. A user of the cellular telephone can become quite frustrated with such low speed data transfers.

Therefore, there exists a need to provide the ability of a mobile terminal, including a cellular telephone, to obtain information from an information server quickly and efficiently that is superior to known systems at the time of filing of this application.

### SUMMARY OF THE INVENTION

The present invention is directed to a mobile terminal, application server, and communication system for providing connectivity and interoperability of a mobile terminal to an application server for the requesting and retrieval of information. In particular, the present invention is directed to a mobile terminal that accesses real estate records from an application server for the purposes of allowing a user to search and access real estate records in real-time and as desired. The present invention can be used with any other information request desired if the application server is programmed to handle such requests. Another type of information that may be desired to be obtained via a mobile terminal are medical records, for example.

The mobile terminal requests and displays information to a user locally on the mobile terminal using a threaded, resident application program. The mobile terminal may be a cellular telephone or personal computing device, such as a PALM® computing device that has wireless communication capabilities for example. The resident application program in the mobile terminal is designed to connect the mobile terminal to an application server that also contains a resident application program for providing information and handling information requests from the mobile terminal using a peer-to-peer connection over a cellular telephone network for high speed and efficient data transfer that is an improvement over current systems.

The mobile terminal first establishes communications over a data network, which may be a TCP/IP based data packet network for example, via a cellular telephone network. The cellular telephone network contains a public switch telephone network (PSTN) circuit switch. If the data packet from the mobile terminal is a traditional cellular telephone call with data contained therein, the PSTN circuit switch uses a gateway to convert data communication from a mobile terminal to data packets to communicate to the cellular telephone network. The cellular telephone network sends out the data packets over the data network on the Internet. The data communication from the mobile terminal includes an IP address of the server where the data packets should be sent. Routers on the Internet route the data packets to the correct server, if online on the Internet.

If the mobile terminal is equipped to make a data packet call such that a mobile service controller (MSC) in the cellular telephone network recognizes such communication as a data packet, the MSC will direct the data packet from the mobile terminal to a packet access network that will in turn communicate such data packet over the Internet. Note that the data packet will not reach the PSTN circuit switch in this example. With either of the aforementioned methods of communicating a received data packet from the mobile terminal over the Internet, the data packet from the mobile terminal will eventually reach its destined application server also connected to the Internet.

The application server may be a custom designed server that includes a proprietary application program that is state-machine driven. When an application server coupled to a data packet network receives an initial data packet from a mobile terminal, a socket is created to create a “peer-to-peer” connection between the mobile terminal and the application server. Once the mobile terminal has connected the socket to the application server, the mobile terminal and application server can use the socket to transmit and receive data to each other further need to establish a connection so long as the mobile terminal keeps its connection open with the cellular telephone network. In this manner, the communications between the mobile terminal and the application server are efficient and quick since the burden of establishing overhead for subsequent communication requests made by the mobile terminal of the application server and vice versa is non-existent due to the socket.

Another feature of the application server is that it contains a proprietary application program in program store instead of a web browser server or other non-proprietary application software. This allows the application program to efficiently service requests to and from the mobile terminal. The application program in the application server is comprised of a state-machine driven program that is cognizant of the various states in which the mobile terminal can be so that the application program has the ability to service such requests based on a previous state of the mobile terminal so that only minimal data transfer is required to service requests. The mobile terminal also executes a proprietary application program that is designed to be compatible with the application program in the application server so that both programs are cognizant of what state the mobile terminal, or socket connection, is in so that service requests can be made efficiently.

The mobile terminal may also be configured to allow a user to specify a desired IP address for connection to a server for information requests. The mobile terminal may be comprised of a housing that includes a visual display. The mobile terminal may include an input pad that is used for inputting information into the mobile terminal by a user. The input pad may be comprised of input buttons that are shortcuts to menu structures present within the mobile terminal.

The mobile terminal may also be configured to provide the ability to configure the IP addressing of communications via a configuration screen. The configuration screen comprises a primary web address field and a secondary web address field. The mobile terminal will attempt to connect to the web address designated by the secondary web address field if a connection to the application server cannot be made successfully using the web address designated by the primary web address field.

The present invention also provides for the ability to have redundant application servers as previously described above. In the event that a user of a terminal device changes his or her password when connected to one of the application servers, the application servers will periodically connect to each other to update each other's password files in the event that a password has been updated on one application server, but not the other.

The present invention also provides for the ability of the application server to download information needed from an information server in order to perform service request from the mobile terminal. The application server can connect to an information server over the Internet and download information that can be stored in the data store of the application server for later searching and retrieval.

Those skilled in the art will appreciate the scope of the present invention and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the invention, and together with the description serve to explain the principles of the invention.

FIG. 1 illustrates a schematic diagram of the communication architecture of the present invention;

FIG. 2 illustrates a communication configuration screen of the mobile terminal in accordance With one embodiment of the present invention;

FIG. 3 illustrates a connect screen of the mobile terminal in accordance with one embodiment of the present invention;

FIGS. 4A and 4B illustrate a flowchart diagram of the connection process performed by the mobile terminal in accordance with one embodiment of the present invention;

FIGS. 5A and 5B illustrate a schematic diagram of the state-machine executed by the application server in accordance with one embodiment of the present invention;

FIG. 6A illustrates a schematic diagram of the query screen, house menu of the mobile terminal in accordance with one embodiment of the present invention;

FIG. 6B illustrates a schematic diagram of the query screen, location menu of the mobile terminal in accordance with one embodiment of the present invention;

FIG. 6C illustrates a schematic diagram of the query screen, additional menu of the mobile terminal in accordance with one embodiment of the present invention;

FIG. 7 illustrates a schematic diagram of the list of matching houses screen of the mobile terminal in accordance with one embodiment of the present invention;

FIG. 8 illustrates a schematic diagram of the general information screen of the mobile terminal in accordance with one embodiment of the present invention;

FIG. 9 illustrates a schematic diagram of the more detailed information screen of the mobile terminal in accordance with one embodiment of the present invention;

FIG. 10A illustrates a schematic diagram of the listing agent screen of the mobile terminal in accordance with one embodiment of the present invention;

FIG. 10B illustrates a schematic diagram of the location details screen of the mobile terminal in accordance with one embodiment of the present invention;

FIG. 10C illustrates a schematic diagram of the interior details screen of the mobile terminal in accordance with one embodiment of the present invention;

FIG. 10D illustrates a schematic diagram of the exterior details screen of the mobile terminal in accordance with one embodiment of the present invention;

FIG. 10E illustrates a schematic diagram of the lot details screen of the mobile terminal in accordance with one embodiment of the present invention;

FIG. 10F illustrates a schematic diagram of the school information screen of the mobile terminal in accordance with one embodiment of the present invention;

FIGS. 10G-1-10G-3 illustrate schematic diagrams of picture screens of the mobile terminal in accordance with one embodiment of the present invention;

FIG. 11 illustrates a schematic diagram of the additional list of matching houses screen of the mobile terminal in accordance with one embodiment of the present invention that may be displayed when a user hits the “NEXT” button on the listing of matching houses screen illustrated in FIG. 7;

FIG. 12 illustrates a schematic diagram of the change password screen of the mobile terminal in accordance with one embodiment of the present invention;

FIG. 13 illustrates a flowchart diagram of the change password process performed by the mobile terminal and the application server in accordance with one embodiment of the present invention;

FIG. 14 illustrates a schematic diagram of redundant application servers coupled to a real estate multiple listing service (MLS) listing server in accordance with one embodiment of the present invention;

FIGS. 15A and 15B illustrate a flowchart diagram of updating of password information between redundant application servers in accordance with one embodiment of the present invention;

FIG. 16 illustrates a flowchart diagram of downloading MLS listing information from a MLS listing server to an application server in accordance with one embodiment of the present invention;

FIG. 17 illustrates a flowchart diagram of downloading pictures data from a MLS listing server to an application server in accordance with one embodiment of the present invention; and

FIG. 18 illustrates a flowchart diagram of retrieving and converting a picture file stored in the application server before communicating to a mobile terminal for display in accordance with one embodiment of the present invention.

### DETAILED DESCRIPTION OF THE PREFERRED EMBODIMENTS

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

In general, the present invention is directed to a mobile terminal, application server, and communication system for providing connectivity and interoperability of a mobile terminal to an application server for the requesting and retrieval of information. In particular, the present invention is directed to a mobile terminal that accesses real estate records from an application server for the purposes of allowing a user to search and access real estate records. The present invention can be used with any other information request desired if the application server is programmed to handle such requests, as will be later described in this application. Another type of information that may be desired to be obtained via a mobile terminal are medical records, for example.

The mobile terminal requests and displays information to a user locally on the mobile terminal using a resident application program. The threaded, resident application program in the mobile terminal is designed to connect the mobile terminal to an application server that also contains a resident application program for providing information and handling information requests from the mobile terminal using a peer-to-peer connection over a cellular telephone network.

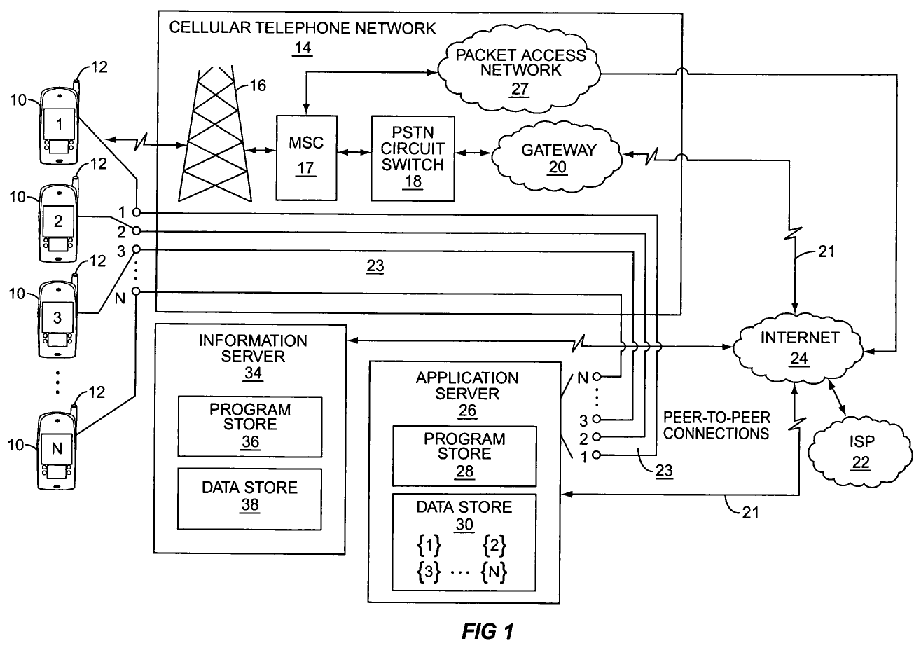

FIG. 1 illustrates the communication architecture in accordance with one embodiment of the present invention. One or more mobile terminals 10 may be in the possession of individual users. The mobile terminal 10 may be a cellular telephone, such as the kyocera® Model QCP™ 6035, for example, which is powered by the PALM® operating system (OS). The mobile terminal 10 may also be a Personal Digital Assistant (PDA), such as a Palm® personal computing device, that has wireless communication abilities. The mobile terminal 10 may be any type of computing device that allows application software to be programmed into the terminal and allows execution of such application software for establishment of data communications using an IP address, allows input from a user, and contains a display for output of information to a user. Each mobile terminal 10 typically contains an antenna 12 that provides the ability for the mobile terminal 10 to transmit and receive radio frequency signals.

When it is desired for the mobile terminal 10 to establish communications for information requests, the mobile terminal 10 must first establish a connection to a data network 21, which may be a TCP/IP based data packet network for example. In the present invention, the mobile terminal 10 first establishes communication with a cellular telephone network 14. The cellular telephone network 14 is a system that is provided by a typical cellular telephone provider. A signal from the mobile terminal 10 is sent via its antenna 12 to a transceiver station 16 in the cellular telephone network 14. Depending on the type of mobile terminal 10 and its capabilities, the mobile terminal 10 either communicates a data packet to the transceiver station 16 without the overhead of a cellular phone call, or communicates the data packet contained within what looks like a cellular phone call. The present invention is adaptable to either scenario.

For the later scenario above, the transceiver station 16 in turn relays the signal from the mobile terminal 10 to a mobile switching center (MSC) 17 which in turn recognizes the communication as a call in which it relays the signal to a public switch telephone network (PSTN) circuit switch 18. The PSTN circuit switch 18 may be capable of handling plain old telephone service (POTS), cellular telephone communications, integrated services digital network (ISDN) communications, and the like. The PSTN circuit switch 18 directs a call or a data communication from a mobile terminal 10 to the proper circuit to then establish a connection.

After the PSTN circuit switch 18 receives a data communication from a mobile terminal 10 via reception by the transceiver station 16, the call is recognized by the PSTN circuit switch 18 as a data communication. In response, the PSTN circuit switch 18 forwards the data communication to a gateway 20. The gateway 20 converts the call from the mobile terminal 10 to an Internet phone call or data packets in the form of an Internet protocol (IP). The data communication from the mobile terminal 10 also carries a specified IP address of a server where the data communication is to be sent after the data communication reaches the Internet 24. The cellular telephone network 14 and the gateway 20 next transfers the converted data packet to the Internet 24. This allows the data packets from the mobile terminal 10 to be communicated out over the Internet 24.

The Internet 24 and its routers (not shown) communicate the data packet from the mobile terminal 10 with a specified IP address. The delivery of data packets based on an IP address carried in a data message is sometimes referred to as a “connectionless” delivery. A commonly known protocol that may be used by the gateway 20 of the cellular phone network 14 to communicate data packets from a mobile terminal 10 to a server is the TCP/IP protocol. Further, an ISP 22 may be connected to the Internet 24 to provide the ability for the cellular telephone network 14 to provide data packets to and from the Internet 24.

For the other scenario, which is used for the remainder of the description in this application, where the mobile terminal 10 is capable of communication data to a cellular telephone network 14 such that the cellular telephone network 14 can recognize such communication as a data transfer and not as a voice cellular phone call, a mobile terminal 10 communicates the data packet to the transceiver station 16 just as previously described. The transceiver station 16 relays the data packet from the mobile terminal 10 to the MSC 17, also as previously described. The MSC 17 recognizes that the communication from the mobile terminal 10 is a data packet rather than a cellular phone call and will therefore direct the data packet to a packet access network 27 rather than through the PSTN circuit switch 18. This communication standard is described in CDMA 2000 standard as is known to one of ordinary skill in the art.

The packet access network 27 will direct the data packet out to the Internet 24 for eventual delivery to the specified IP address, which will be the application server 26 in the example in this application. Please note that while this alternative form of data packet communication via a mobile terminal 10 is not a telephone call, this application may refer to such communication as a call, which is to be interpreted as applying to both data that is switched through the PSTN circuit switch 18 and data that is not switched through the PSTN circuit switch 18, but rather directed to the Internet 24 via the packet access network 27. Routers direct the data packet communication to the correct server having the specified IP address. Eventually, the data packet will reach an application server 26 addressable at the specified IP address.

After the initial data packet from the mobile terminal 10 reaches the application server 26, the application program resident in a program store 28 of the application server 26 handles the receipt of such data packet. The application server 26 also contains data store 30 that provides memory for storage of data used by the application program and for holding of information that may be requested by the mobile terminal 10. In the present invention, the application server is a custom designed server that includes a proprietary application program. The allows the flexibility of the application server 26 and the mobile terminal 10 to communicate at higher speeds and with less over head, as will be later discussed in this application.

When the application server 26 receives an initial data packet from a mobile terminal, the application server 26 creates a socket 23. A socket 23 is a dedicated and open communication path between a network connection and a specific destination address—in this case the IP address of the server specified by the mobile terminal 10. FIG. 1 illustrates four sockets 23 labeled as “peer-to-peer” connections 1, 2, 3, and N. This representation is simply to illustrate that the application server 26 can create any number of sockets 23 with any number of mobile terminals 10. Each mobile terminal 10 that establishes communication with the application server 26 is assigned a different socket 23 by the application server 26. An example of a socket system call that may be made by the application server 22 to create a socket 23 is:
Result=socket (pf, type, protocol)

Where “pf” is the protocol family, like TCP/IP for example, “type” specifies the type of communication desired, and “protocol” specifies the protocol. The initial creation of the socket 23 is not bound to the IP address specified by the mobile terminal 10.

Once the socket 23 is created, the application server 26 binds the socket 23 on the data packet network 21. An example of a socket binding call that may be made by the application server 26 to bind the socket 23 may be as follows:
Bind (socket [from “Result”], IP address, address length);

Next, the mobile terminal 10 connects to the socket 23 created by the application server 26 since the socket 23 is initially created by the application server 26 in an unconnected state. The connection binds the mobile terminal 10 connection to the cellular telephone network 14 to the socket 23, placing it in a connected state with the application server 26. An example of a socket connect call that may be made by the mobile terminal 10 to connect to the socket 23 created by the application server 26 may be as follows:
Connect (Socket, IP address, address length);

Once the mobile terminal 10 has connected the socket 23 created by the application server 26, the application server 26 and the mobile terminal 10 can use the socket 23 to transmit and receive data to and from the application server 26 without the further need to establish a connection so long as the mobile terminal 10 keeps its connection open with the cellular telephone network 14 and with the established socket 23 and/or the application server 26 keeps the socket 23 open. In this manner, the communications between the mobile terminal 10 and the application server 26 are efficient and quick since the burden of establishing overhead for subsequent communication requests made by the mobile terminal 10 of the application server 26 and vice versa can simply be made using the already established socket 23.

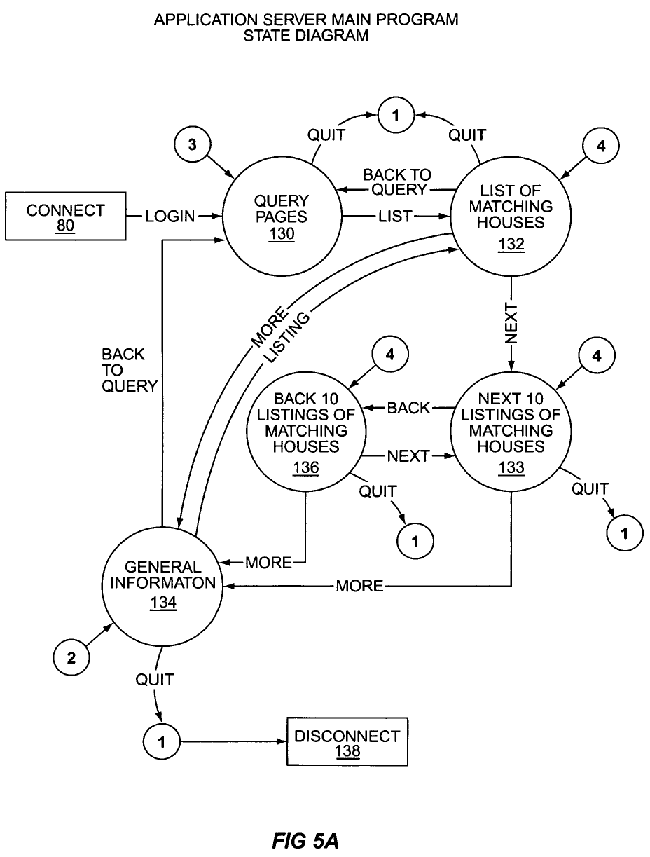

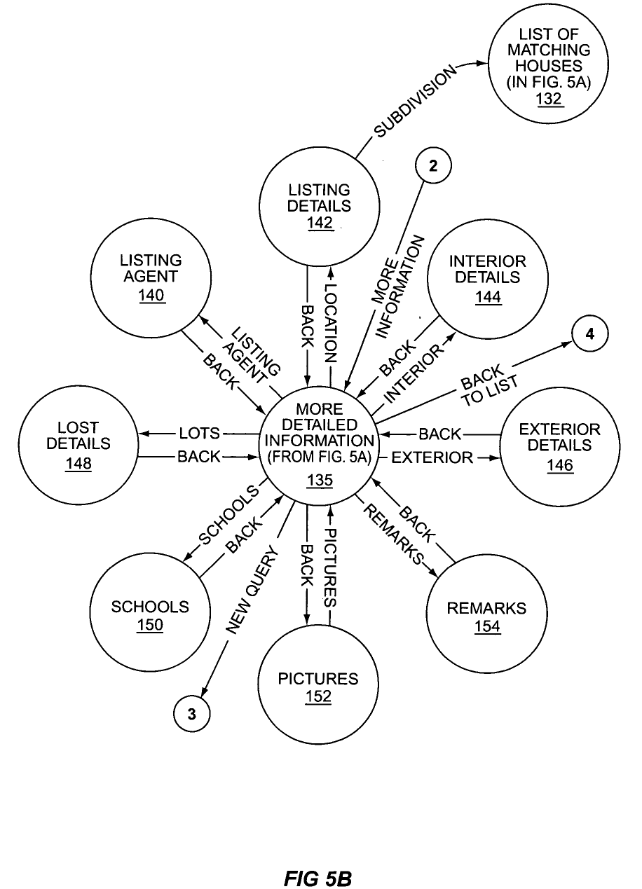

Another feature of the application server 26 is that it contains a proprietary application program in program store 28 instead of a web browser server or other non-proprietary application software. This allows the application program to efficiently service request to the mobile terminal 10. The application program in the application server 26 is comprised of a threaded per connection that contains a state-machine driven program that is cognizant of the various states in which the mobile terminal 10 can be in so that the application program has the ability to service such request based on a previous state of the mobile terminal 10. Each peer-to-peer connection connects the application on the mobile terminal 10 and a thread of the server application program on the application server 26. The mobile terminal 0 also contains a proprietary application program within that is designed to be compatible with the application program in the application server 26 so that both program are cognizant of what state the mobile terminal 10 is in so that service requests can be made efficiently, as will be described in more detail below in FIGS. 5A and 5B.

FIG. 1 also illustrates an information server 34 that is coupled to the Internet 24. The information server 34 also may contain a program store 36 and a data store 38. The mobile terminal 10 does not establish a connection with the information server 34. Rather, the application server 26 is configured, due to its connection to the Internet 24 to be able to establish communication with other servers connected to the Internet 24 including the information server 34 illustrated. It may be that the application server 26 either does not have the information that may be requested from the mobile terminal 10 resident in its data store 30 or does not have an updated version of such information. For example, in the context of a real estate records retrieval application, the information server 34 may be a multiple listing service (MLS) database that contains listing records for house listed by local real estate agents. The application server 26 may not maintain the MLS records itself, but simply download these records from another source. In the present embodiment, the application server 26 connects to the information server 34 to obtain the MLS records as desired.

IP Address Configuration

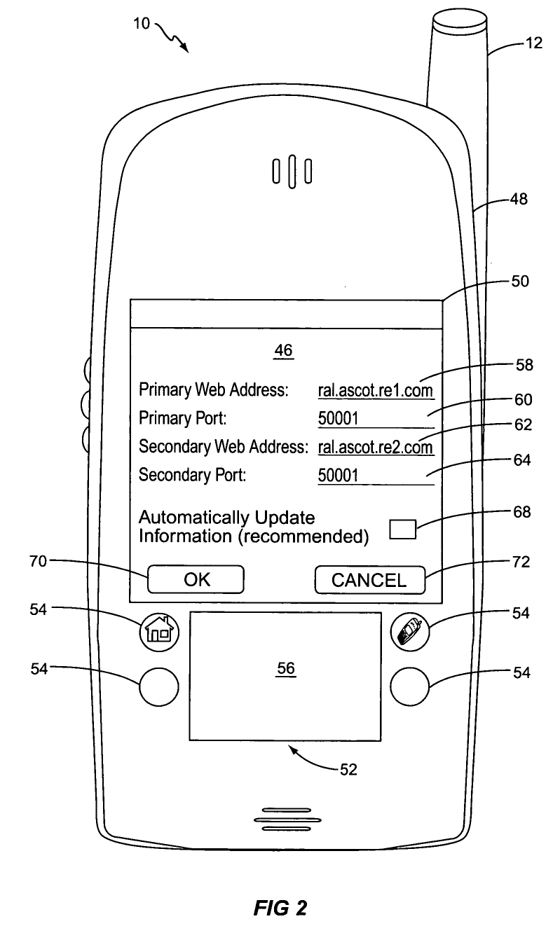

FIG. 2 illustrates an example of a mobile terminal 10 that may be used with the present invention. The mobile terminal 10 is comprised of a housing 48 that includes a display 50. The mobile terminal 10 may include an input pad 52 that is used for inputting information into the mobile terminal 10 by a user. The input pad 52 may be comprised of input buttons that are shortcuts to menu structures present within the mobile terminal 10. For example, the input buttons 54 displayed in FIG. 2 are such as those on a Palm® device. Input pad 52 may also contain a writing pad 56 so that a user can use a writing pin to input information into the mobile terminal 10, as is well known.

FIG. 2 also illustrates an example of a configuration screen 46 that may be provided by the mobile terminal 10 to allow a user to program an IP address for the mobile terminal 10 to communicate to the cellular telephone network 14 and the Internet 24. The configuration screen comprises several fields of information that must be input by the user to designate an IP addresses for the application server 26. In the example illustrated in FIG. 2, a primary web address field 58 is provided by a user using the input pad 52 so that the IP address of a primary application server 26 to which the mobile terminal 10 should attempt to connect when communications are established can be specified. The configuration screen 46 also provides a primary port 60 for the primary web address 58 so that communication from the mobile terminal 10 can establish a connection with the application server 26 via the primary port 60 as is well known. The configuration screen 46 also provides the ability for the user to specify a secondary IP address 26 in a secondary web address field 62 and a secondary port in a secondary port field 64. As discussed later in this application, if the mobile terminal 10 cannot connect to the application server 26 located at the primary web address (IP address), the mobile terminal 10 will attempt to connect to an application server 26 located at the secondary web address (IP address) for redundancy purposes.

The configuration screen 46 also provides an automatic update button 68. The automatic update button 68 gives permission to the application server 26 to change the primary web address field 58 and primary port field 60 as well as the secondary web address field 62 and the secondary port field 64 to redirect future communications of the mobile terminal 10. For instance, it may be known by the application server 26 that the address of the application server 26 will change in the near future, and the automatic update button 68 feature allows the application server 26 to pass back new communication addresses for such future communication unknown and seamlessly to the user of the mobile terminal 10. Once the information is entered by the user on the configuration screen 46 using the input pad 52, the user can press the “OK” button 70 for the IP address settings to be stored in the mobile terminal 10 for later use when establishing a communication session over the cellular telephone network 26. The user may also press the “CANCEL” button 72 at any time, in Which case any information input into the fields 58, 60, 62, 64, 68 will not be stored in the mobile terminal 10. Any previous settings for these fields 58, 60, 62, 64, 68 will be retained in this instance.

Establishing Communications Between Mobile Terminal and Application Server

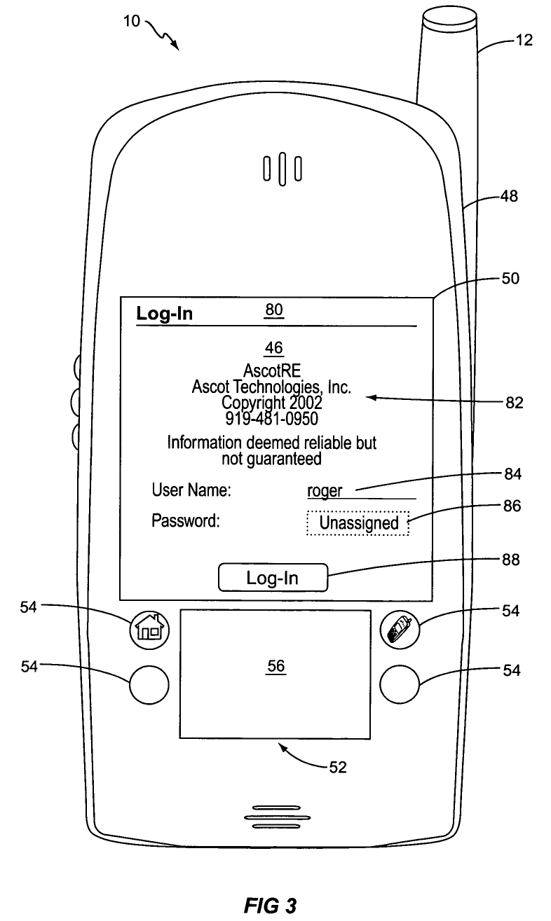

FIG. 3 illustrates a connect screen 80 on the mobile terminal 10. Once the IP address configuration information is stored in the mobile terminal 10, as illustrated in FIG. 2, the mobile terminal 10 is ready to be connected to an application server 26 via the cellular telephone network 14. The connect screen 80 may contain information 82 regarding the application software that is resident in the mobile terminal 10, such as the manufacturer and version number of the software, for example. The connect screen 80 also contains a user name field 84 and a password field 86. A user of the mobile terminal 10 in the present example must have a valid user name and password to be able to successfully establish a communication with the application server 26.

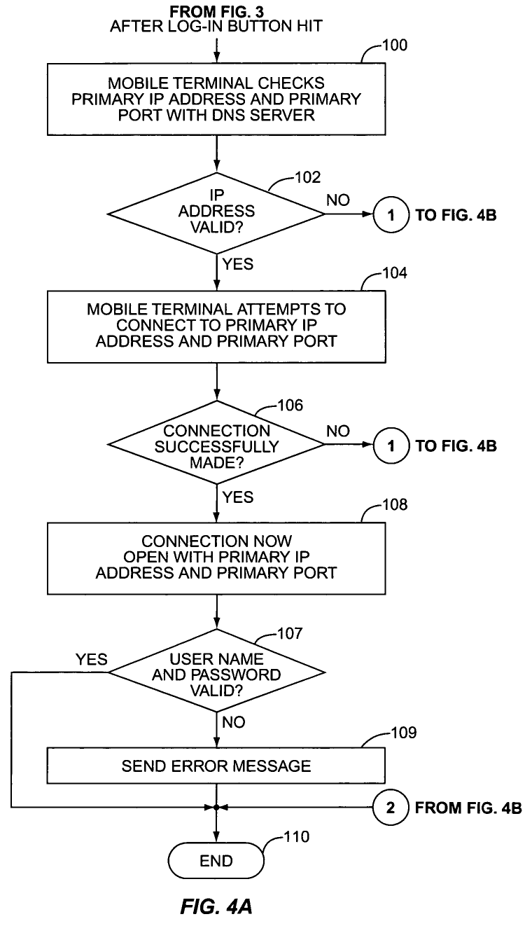

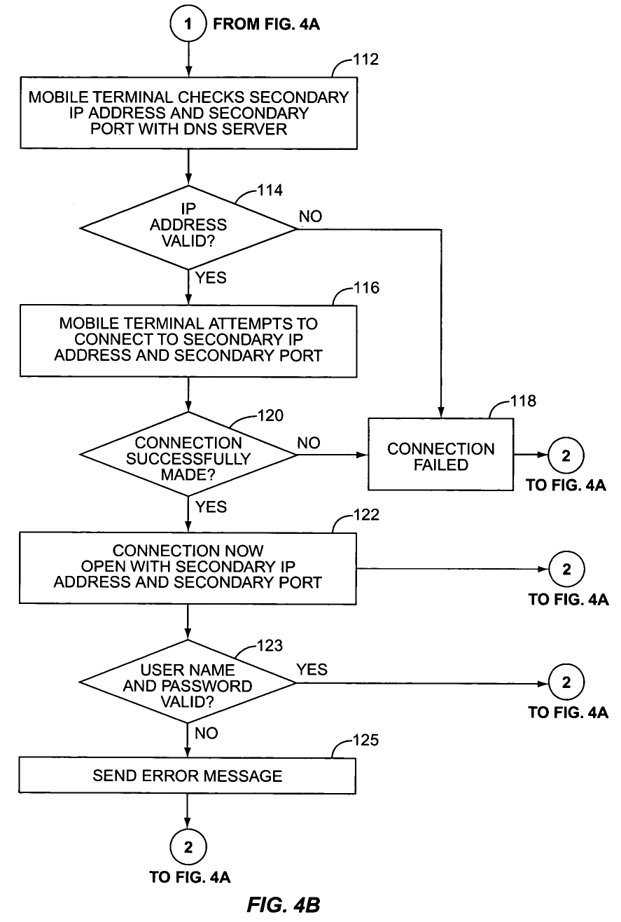

The user enters his or her user name in the user name field 84 and a password in the password field 86 that corresponds to the user name. Next, the user can press the “LOGIN” button 88 to establish a connection. FIGS. 4A and 4B illustrate flowcharts of the mobile terminal 10 attempting to establish a connection with the application server 26 using the specified user name and password entered by the user on the connect screen 80.

After the user hits the “LOGIN” button 88 on the connect screen 80 illustrated in FIG. 3, the mobile terminal 10 makes a phone call to the cellular telephone network 14 to establish an initial connection, as previously discussed above in FIG. 1. This phone call allows the mobile terminal 10 to access functions that are provided by the data packet network 21 including the ability to connect to the packet access network 27/lnternet 24 and perform network functions, like TCP/IP function for example. One of these functions is the ability of the mobile terminal 10 to request confirmation of the validity of a specified IP address entered by the user in the primary or secondary web address field 58, 62. This is to ensure that the IP address specified by the user exists on the Internet 24. This process is illustrated in FIGS. 4A and 4B in one embodiment of the present invention.

As illustrated in FIGS. 4A and 4B, after the mobile terminal 10 establishes a successful call with the cellular telephone network 14 (block 100), the mobile terminal 10 requests the cellular telephone network 14 to validate the primary web (IP) address provided in the primary web address field 58 by the user with a domain name server (DNS) (block 101). The packet access network 27 determines if the primary IP address is valid. If the primary IP address is not valid (decision 102), the packet access network 27 will inform the mobile terminal 10 and the mobile terminal 10 will request the packet access network 27 to confirm the validity of the secondary IP address entered in the secondary web address field 62 by the user on the configuration screen 46. This path will be later described in FIG. 4B.

If the primary IP address is valid from decision 102, the mobile terminal 10 attempts to establish a peer-to-peer connection with the application server 26 as previously described, where the IP address of the application server 26 is the primary web address (block 104). If the packet access network 27 is able to establish a successful peer-to-peer connection with the application server 26, a socket 23 is established between the mobile terminal 10 and the application server 26 using the primary port (block 108). This connection remains open until terminated by the mobile terminal 10. After a successful connection is made between the application server 26 at the primary web address the mobile terminal 10, the application program determines if the user name and password are valid (decision 107). If so, the connection remains open and the process ends (block 110). If not, the application program sends an error message to the mobile terminal 10 which in turn displays an error message on the display 50 (block 109), and the process ends (block 110).

Turning to FIG. 4B, if the mobile terminal 10 was unable to successfully establish a connection with the application server 26 at the primary IP address in decision 106, the mobile terminal 10 will request the packet access network 27 confirm the validity of the secondary IP address entered in the secondary web address field 62 by the user on the configuration screen 46 (block 112). If the secondary IP address is also not valid, as confirmed by the packet access network 27 to the mobile terminal 10, the mobile terminal will indicate to the user that the connection failed (block 118) and the connection process ends (block 110).

If, however, a connection was successfully made between the packet access network 27 and the application server 26 located at the secondary IP address using the secondary port, the packet access network 27 will communicate to the mobile terminal 10 that a connection is now successfully open with an application server 26 located at the secondary IP address (block 120), the application program determines if the user name and password are valid (decision 123). If so, the connection remains open and the process ends (block 110). If not, the application program sends an error message to the mobile terminal 10 that in turn displays an error message oh the display 50 (block 125), and the process ends (block 110).

Application Server Application Software

As previously stated above, the application server 26 includes application software in the program store 28 that executes on the application server 26 to handle information requests to and from the mobile terminal 10 once the peer-to-peer connection is established with the mobile terminal 10. Once a successful peer-to-peer connection is established between the mobile terminal 10 and the application server 26, the application program on the application server 26 will establish a thread in the data store 30 for such mobile terminal 10. The application program has the ability to establish multiple threads communicating between the state machine contained in that thread and its associated mobile terminal 10. A multi-threaded application allows overlapping of computation and communication between the processor that executes the application program in the application server 26 and for one or more mobile terminals 10.

The threads of the application program are state-machine driven, as will be further discussed below, so that the application program can store a specific state for each mobile terminal 10. In this manner, the application program services a plurality of mobile terminals 10 in a seamless fashion and only has to interact with a mobile terminal 10 in a minimal way to perform a service request since the application program is cognizant of what state the mobile terminal 10 is in and/or previously was in. Use of a threaded, state-machine aware application server 26, peer-to-peer connections, and proprietary, compatible application software on both the mobile terminal 10 and the application server 10 provides an extremely high effective data speed requesting service and communication between the mobile terminal 10 and the application server 26. This is specifically illustrated in FIGS. 5A and 5B, in which the state-machine of the application server 26 is illustrated and described.

FIG. 5A illustrates the top level state diagram of the application program executed on the application server 26 that handles communication to and from a mobile terminal 10 that has established a peer-to-peer connection with the application server 26, as previously described. After the mobile terminal 10 connects to the application server 26 via the connection screen (block 80) and the login process is completed, as previously described in FIGS. 4A and 4B, the application server 26 enters into the query state 130 for the specific mobile terminal 10. As previously discussed, different mobile terminals 10 that have established threaded communications with the application server 26 may be in various states of the state-machine illustrated in FIGS. 5A and 5B on the application server 26

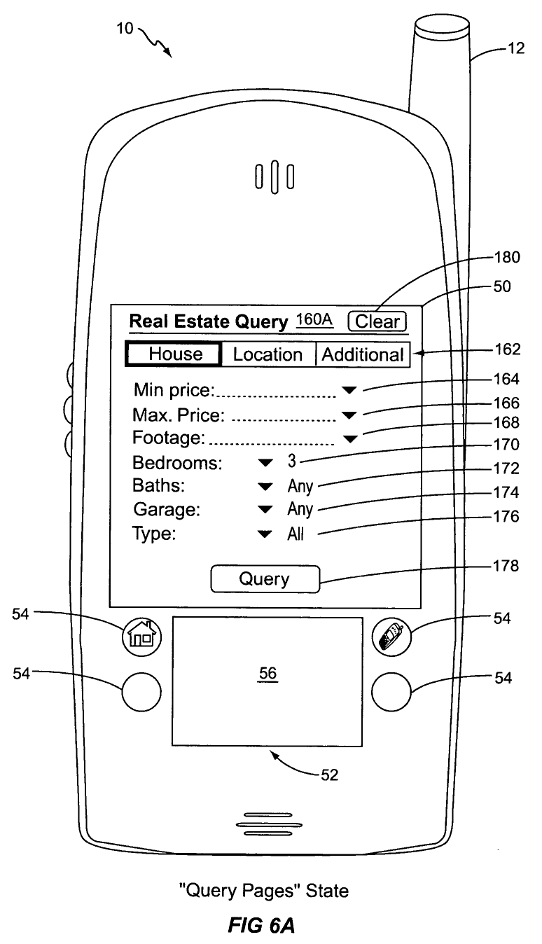

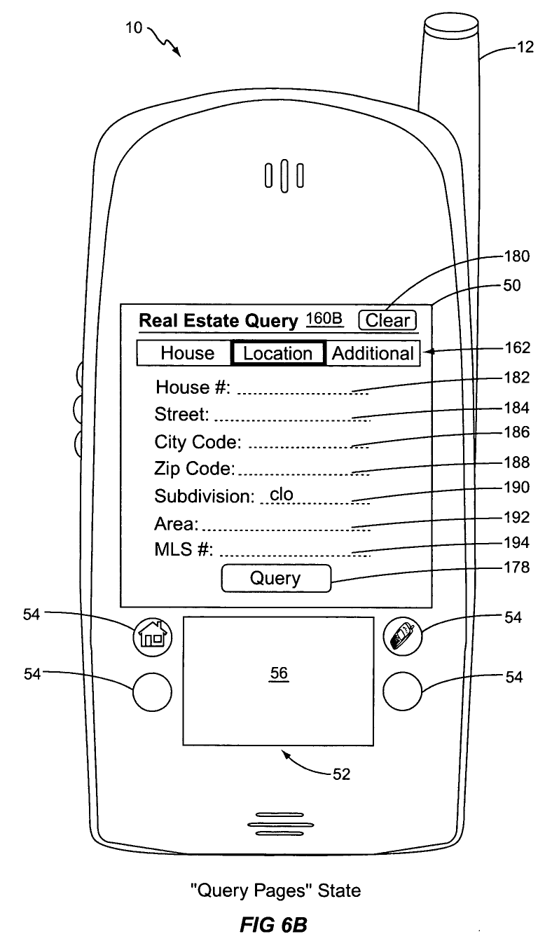

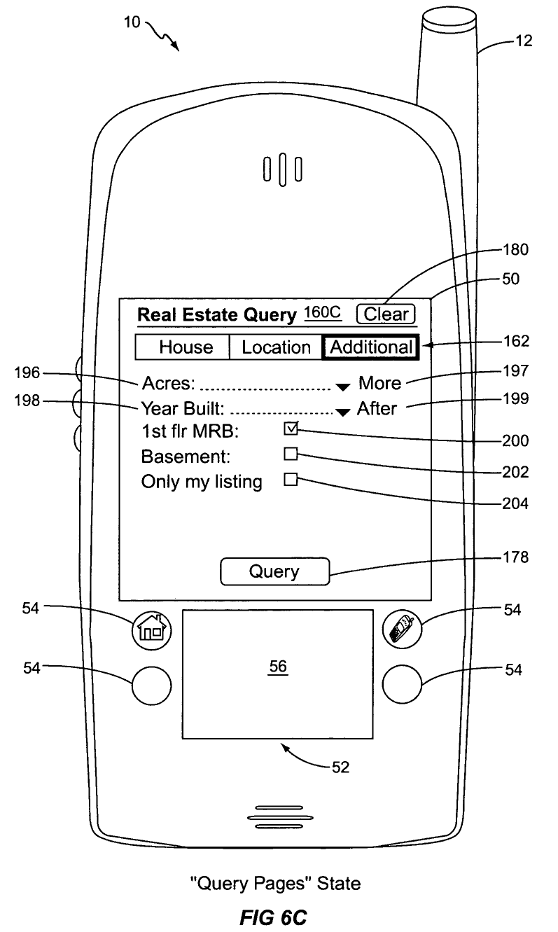

FIG. 5A shows the various states and the methods of the application server 26 transferring a mobile terminal 10 from one state to another as the mobile terminal 10 makes data requests to the application server 26. Eventually, the mobile terminal 10 will disconnect from the cellular telephone network 14 in which the application server 26 will end the specific thread which was communicating with such mobile terminal 10 via the disconnect block 138. Each of the states illustrated in FIG. 5A will be described in more detail starting at FIG. 6 of this application.

FIG. 5B illustrates a sub-state-machine for a more detailed information state 135 that can be reached from the general information state 134 in FIG. 5A where additional sub-states are provided for providing various information to a mobile terminal 10 that has previously established a threaded communication session with the application server 26. Rather than further discuss the state-machine on the application server 26 in terms of only describing FIGS. 5A and 5B at this point, this state-machine is described using examples of display screens on the mobile terminal 10 and information that is displayed on the mobile terminal 10 for each state. These screens are illustrated in FIGS. 6A-11 below, with a real estate search and information retrieval application used as the illustration.

Mobile Terminal Screens/Application Program States

Once a mobile terminal 10 has established a successful connection with the application server 26, the application server 26 moves the mobile terminal 10 into the query state 130 as illustrated in FIG. 5A. FIG. 6A illustrates the query screen 160A as displayed on the mobile terminal 10 after a connection is successfully made with the application server 26. The query screen 160A has a query menu 162 as illustrated in FIG. 6A consisting of three choices—a House menu, a Location menu, and an Additional Information menu. The query screen 160A illustrated in FIG. 6 illustrates the House menu. As the user traverses the query menu 162, different fields will appear on the screen 50 to allow the user to input the information designated for a house search in the specific example illustrated. If the user directs the mobile terminal 10 to go to the other two menus—the Location menu and the Additional Information menu, different screens will appear on the display as illustrated in FIGS. 6B and 6C.

Note that the screens are stored in the mobile terminal 10 program store and not transferred by the application server 26 to the mobile terminal 10. Only the data entered by the user and data to be displayed from the application server 10 is transferred between the mobile terminal 10 and the application server 26. This is possible because the application programs executing on both the mobile terminal 10 and the application server 26 are designed to specifically work With each other, and the application server 26 is aware of the state in which the mobile terminal 10 is in on FIGS. 5A and 5B. This is what allows minimal data to be transferred thereby making information requests and receipts fast between the mobile terminal 10 and the application server 26.

On the query screen, House menu 160A, the user may enter a minimum price for the house search in the minimum price screen 164 as illustrated in FIG. 6A. The user may enter a maximum price for a house in the maximum price field 166. The user may also enter a square footage in the square footage field 168, the number of bedrooms in the bedrooms field 170, and the number of baths, number of garages, and the type of the house in the number of bathrooms field 172, number of garages field 174, and the type of house field 176, respectively. The user does not have to enter all of this information; only the information entered will be used for a search request by the mobile terminal 10 to the application server 26. However, the user must enter at least one field in the query screen 160A, 160B or 160C to perform a search criteria.

Note that the user does not have to enter information in each of the illustrated fields in FIG. 6A, but rather only the fields upon which the user desires the search criteria to be based. After the user enters all of the desired information for the real estate query, the user then would hit the “QUERY” button 178 to cause the mobile terminal 10 to send the information entered regarding the real estate query to the application server 26 for searching the data store 30 for real estate matches and to then provide such matches back to the mobile terminal 10 via a data communication. After the user hits the “QUERY” button 178, the mobile terminal 10 sends all of the search criteria for all of the query menu 162 screens to the application server 26 for processing.

FIGS. 6B and 6C illustrate the two additional menus on the query screen menus 162, the Location menu and the Additional Information menu. In FIG. 6B for the location menu for the query screen 160B, the user can enter location information regarding the house to be searched. The user may enter the house number in the house number field 182. The user may enter the street name in the street name field 184. The user can also enter the city code, the zip code, the subdivision name, the area, and the multiple listing service (MLS) number in the city code field 186, the zip code field 188, the subdivision name field 190, the area field 192, and the MLS number field 194, respectively. After the user hits the “QUERY” button 178, the mobile terminal. 10 sends all of the search criteria for all of the query menu 162 screens to the application server 26 for processing.

FIG. 6C illustrates the last menu for the query screen 160C, which is called the Additional Information menu on the query menu 162. On the query screen, Additional Information menu 160C, the user can enter further additional information regarding search criteria for a house. The user can enter a number of acres desired in the acres field 196 and indicate whether the land with the house must be more than the indicated number of acres, equal to the indicated number of acres, or less than the indicated number of acres via the acres field descriptor 197. The user can specify a year built for the house in the year built field 198 and also whether the houses found during the search should be built before or after the indicated year built, or in the indicated year built, in a year built descriptor 199. Further, the user can indicate whether the house search criteria should be limited to houses containing a first floor master bedroom, a basement, and/or only include houses listed by the user as the listing agent based on selection or non-selection of the first floor master bedroom box 200, the basement box 202, and the only my listings box 204, respectively. After the user hits the “QUERY” button 178, the mobile terminal 10 sends all of the search criteria for all of the query menu 162 screens to the application server 26 for processing.

The application server 26 knows, because of the threaded communication with the mobile terminal 10, that the mobile terminal 10 in the query state 130 on FIG. 5A after receiving the search criteria without the mobile terminal 10 having to include this information in its data communication to the application server 26. After the application server 26 receives the search criteria, the application program in the application server 26 will search its house records in data store 30 to compile a list of houses that meet all of the specified search criteria.

Application server 26 will search the stored house listings in the data store 30 that were previously obtained from the information server 34 via the Internet 24, as previously described, to generate a list of matching houses that meet the search criteria. After the application server 26 generates the list of matching houses, this list of matching houses is communicated back to the mobile terminal 10. The application server 26 subsequently changes the state for the mobile terminal 10 to the “List of Matching Houses” state as illustrated in FIG. 5A.

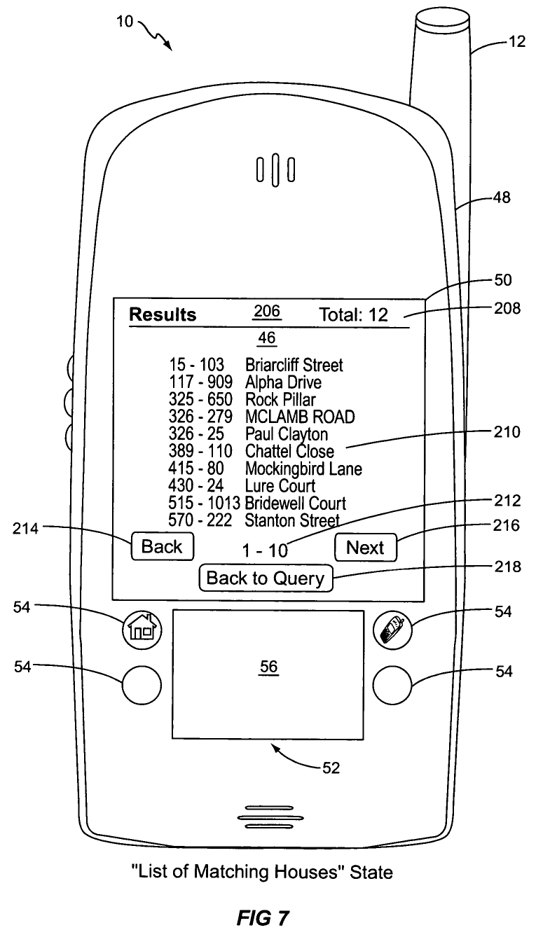

An example of a list Of matching houses that may be generated by the application server 26 is illustrated in FIG. 7. FIG. 7 illustrates a list of matching houses screen 206 displayed on the mobile terminal 10 display 50. The total number of houses that met the search criteria is first indicated on the display 50 in the total number of houses found field 208. In this specific example, twelve total houses were found by the application server 26 that met the search criteria established by the mobile terminal 10 as specified by the user on the query screens 160 illustrated in FIG. 6A-6C. Each of the individual houses that were found that met the search criteria are listed in a results listing 210 on the display 50. In the present example of the mobile terminal 10, only ten house listings that met the search criteria are displayed on the display 50 at a time, with the results listing range listed on a results listing range field 212.

In the present example, since the screen 50 in FIG. 7 is an illustration of an initial house listing results, and because there were more than ten house listings found by the application server 26 that met the search criteria, only the first ten house listings, 1-10, are displayed first on the display 50. If the user desires to review the next search range of listings, which would only include houses 11-12 in the present example since only a total of twelve houses that met the search criteria were found, the user can hit the “NEXT” button 216. If the display 50 is displaying a listing of houses other than the first 1-10 house listings, the user can hit the “BACK” button 214 in combination with the “NEXT” button 216 to traverse the various groups of listings of houses that met the search criteria in groups of ten or less. If the user wants to go back to the query screen 160, as previously illustrated in FIG. 6A-6C, to initiate a new house search, the user can hit the “BACK TO QUERY” button 218.

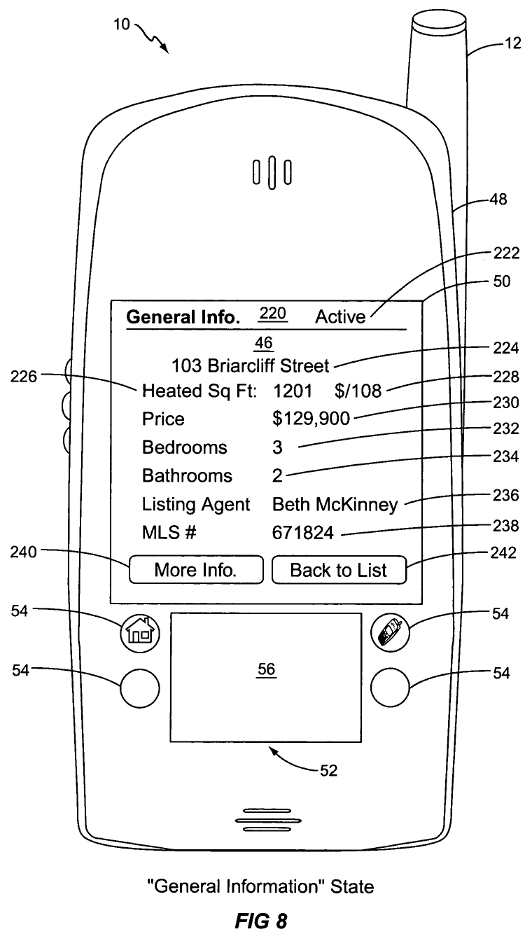

If the user desires to review more detailed information about a particular house listing displayed in the results listing 210, the user can simply select the house on the display 50 for further information to be displayed on the display 50. In this event, the mobile terminal 10 communicates this request to the application server 26 to provide more information about the house listing selected. The application program changes the state for such mobile terminal 10 to the “General Information” state 134 as illustrated in FIG. 5A. The general information results for the house listing selected by the user at the mobile terminal 10 is illustrated in FIG. 8.

FIG. 8 illustrates the general information screen 220 where the house at 103 Briarcliff Street illustrated in the house listing results 210 in FIG. 7 was selected by the user to display additional general information. The general information screen 220 contains several pieces of information regarding the house from the house listing results 210 that are selected by the user. The general information screen 220 includes a status field 222 that is for reporting the current status of the house listing (i.e. active, pending, or withdrawn). The address of the house selected from the house listing results 210 is displayed in the house street location 224. The heated square feet for the house is displayed in the heated square feet location 226, and the price per heated square foot is displayed in the price per square foot location 228. The price of the house is displayed in the price location 230. Lastly, the number of bedrooms, the number of bathrooms, the listing agent, and the MLS number are displayed in the number of bedrooms location 232, number of bathrooms location 234, listing agent name location 236, and MLS number location 238, respectively.

If the user desires to go back to the house listing results 210 illustrated in FIG. 7 to either initiate another query by pressing the “BACK TO QUERY” button 218 or to reverse the house listing results 210 and/or select another listing for display of general information, the user can hit the “BACK TO LIST” button 242 on the general information screen 220. If the user would like more detailed information about a house listing other than what is displayed on the general information screen 220, the user can hit the “MORE INFORMATION” button 240.

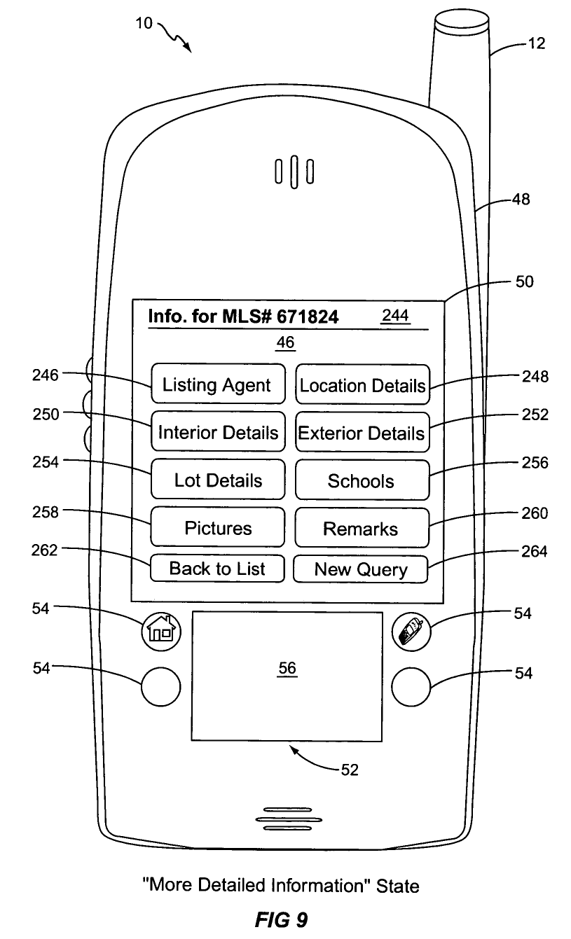

When the user hits the “MORE INFORMATION” button 240, the mobile terminal 10 will communicate this request to the application server 26, and the application server 26 will obtain more information about the house listing desired and communicate such information back to the mobile terminal 10 to be displayed on the display 50. The application server 26 will cause the state of the mobile terminal 10 to move from the “List of Matching Houses” state 132 to the “More Detailed Information” state 135 as illustrated in FIG. 5B. The sub-states that are available from the “More Detailed Information” state 135 are illustrated in FIG. 5B and in FIG. 9.

FIG. 9 illustrates the more detailed information screen 244 on the display 50 of the mobile terminal 10 where eight different types of additional information may be obtained about a listing in the particular example illustrated. These more “detailed information” categories provided in the form of buttons are the “LISTING AGENT” button 246, the “LOCATION DETAILS” button 248, the “INTERIOR DETAILS” button 250, the “EXTERIOR DETAILS” button 252, the “LOT DETAILS” button 254, the “SCHOOLS” button 256, the “PICTURES” button 258, and the “REMARKS” button 260. The user pressing any one of these more information buttons will cause the application server 26 to retrieve this more detailed information and to change the mobile terminal's 10 state to one of the sub-states in the “More Detailed Information” state 135 illustrated in FIG. 5B.

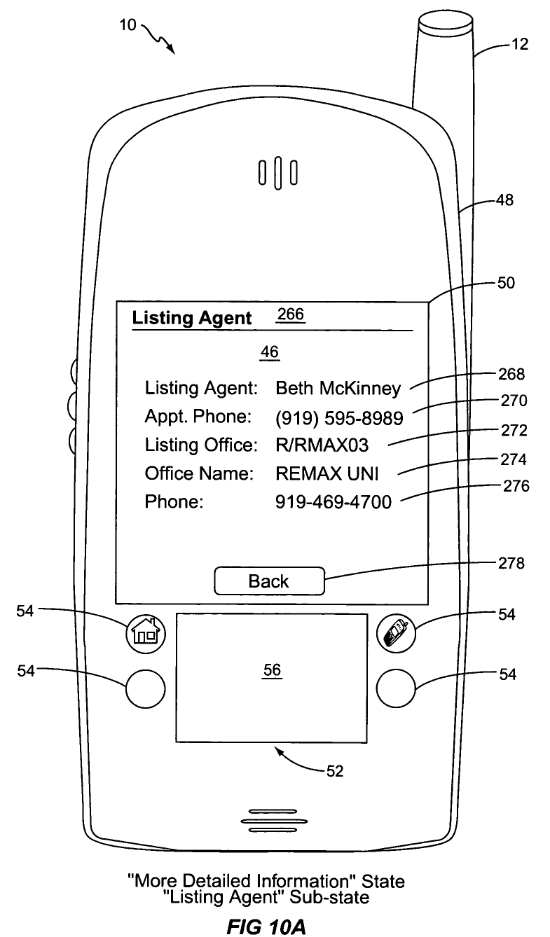

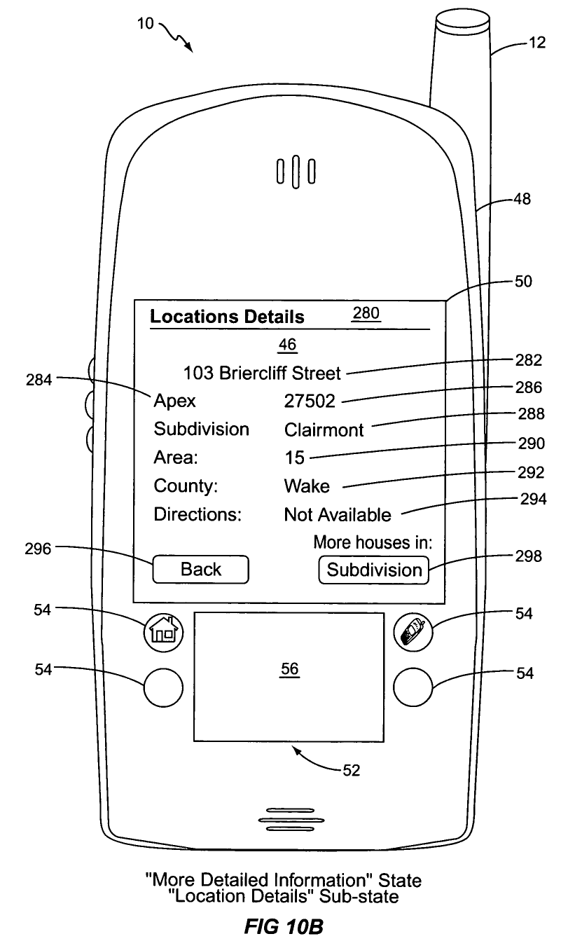

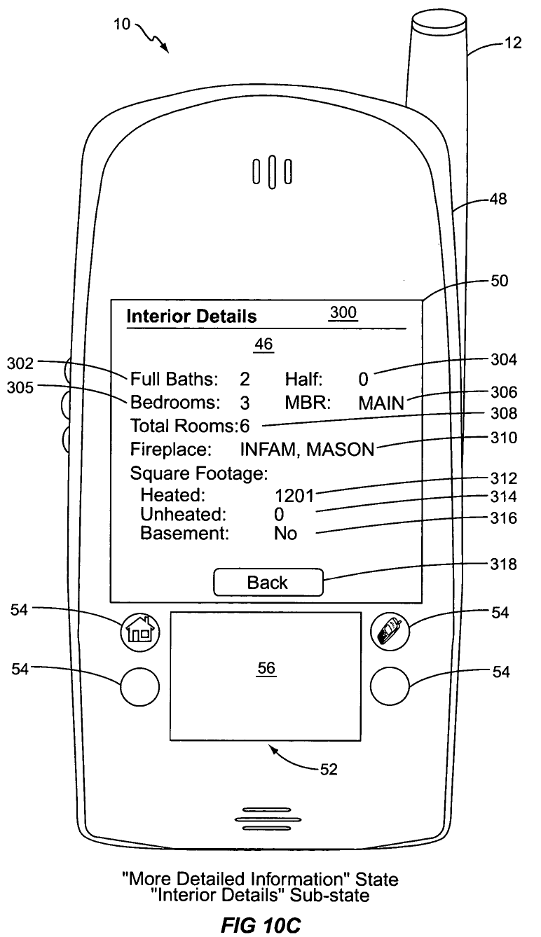

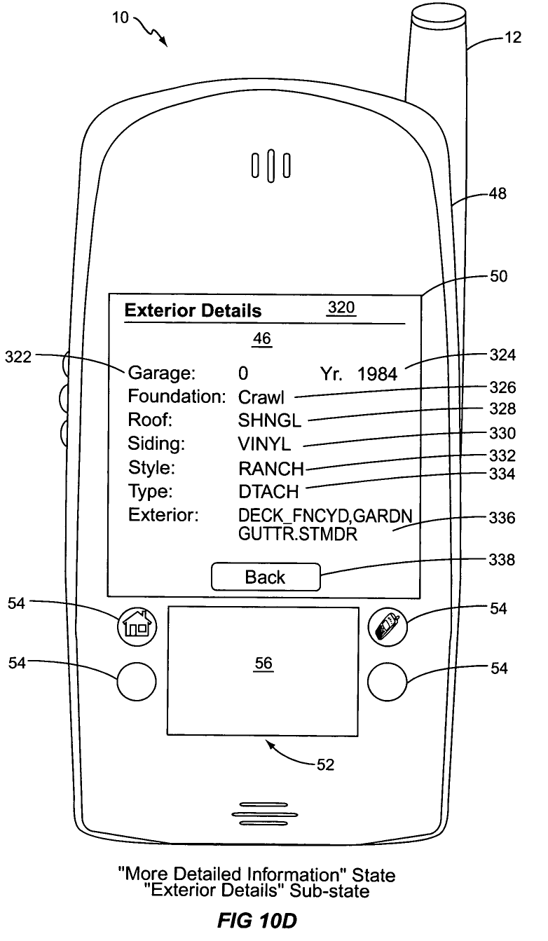

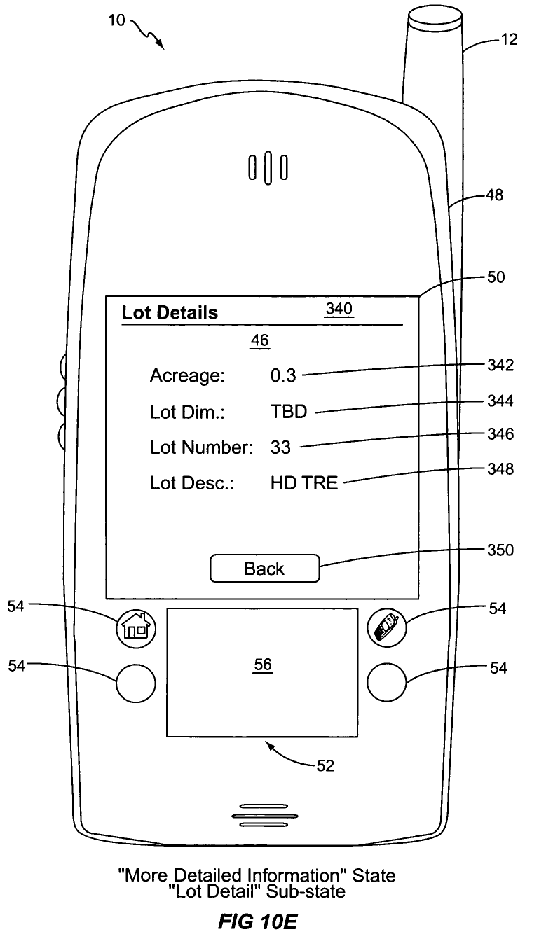

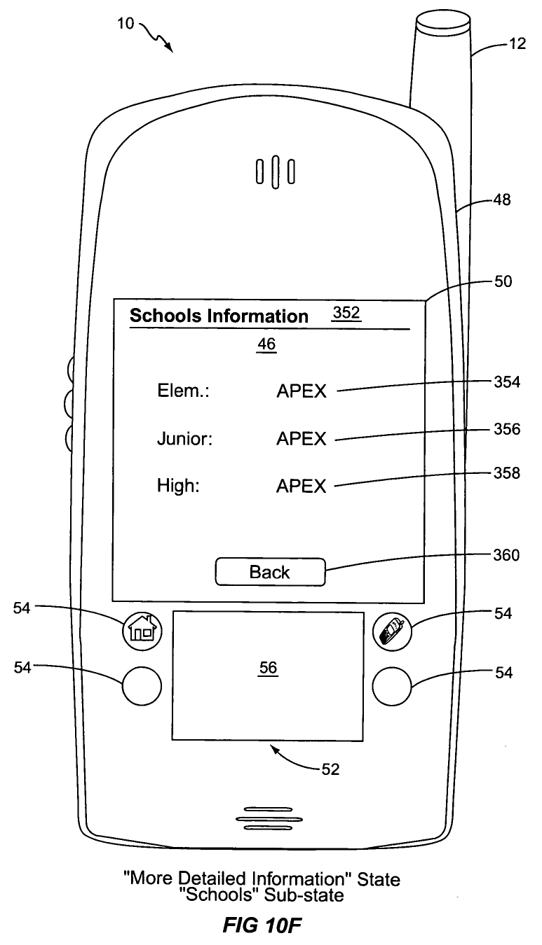

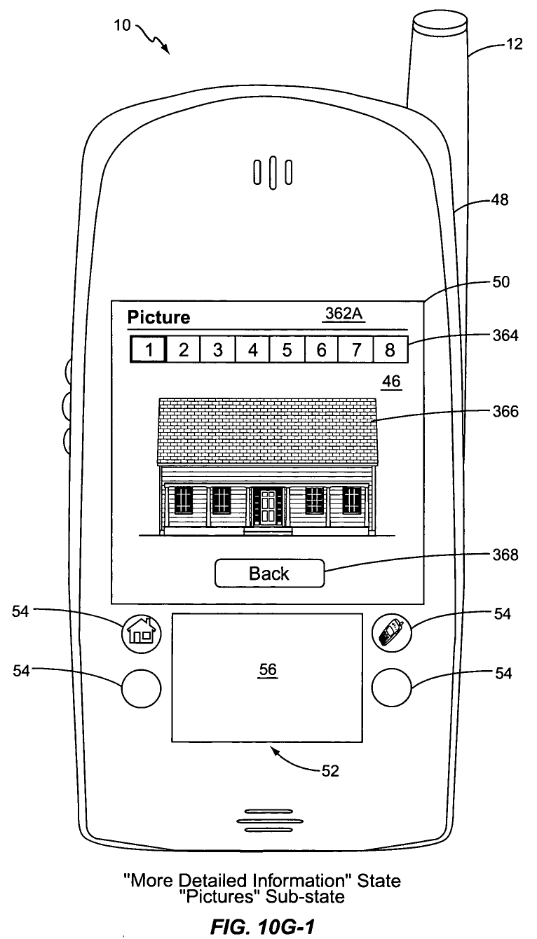

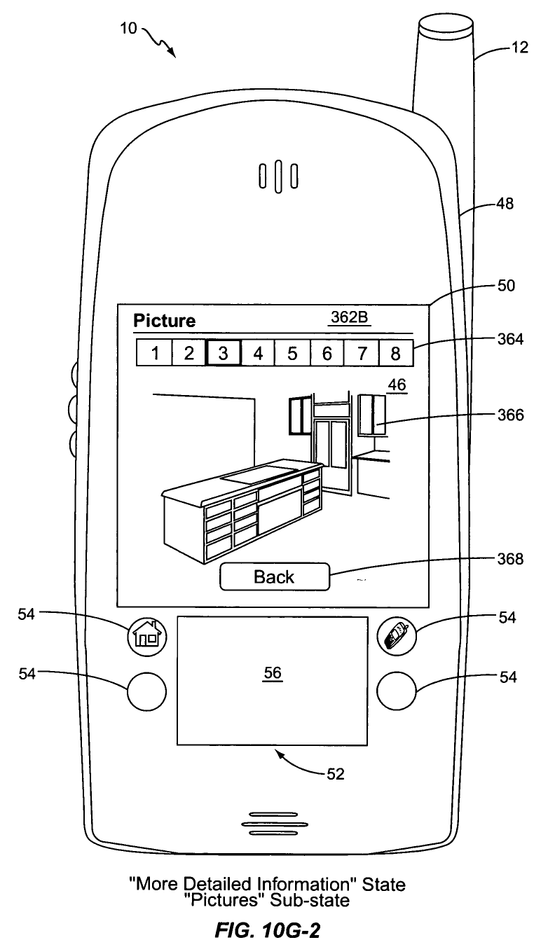

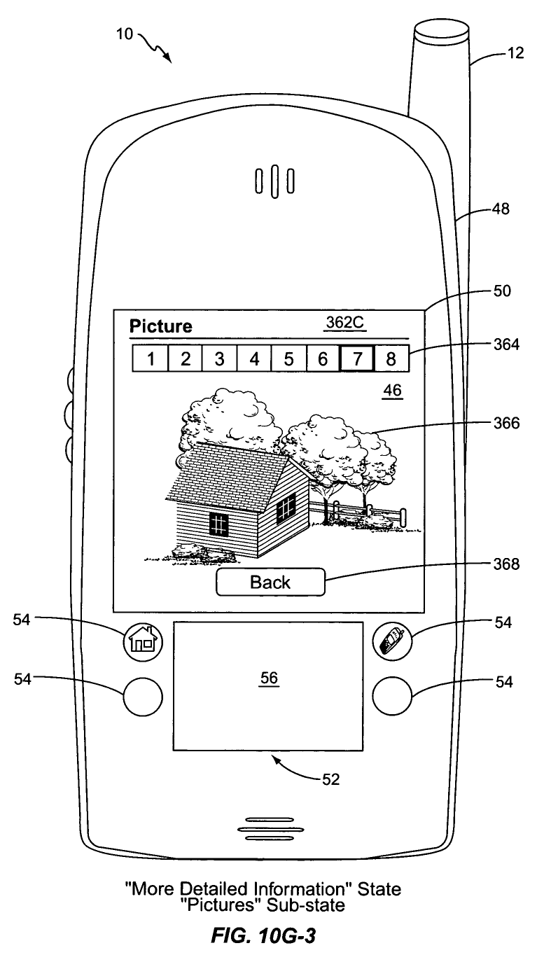

FIGS. 10A through 10G-3 described below illustrate examples of screens that are displayed on the mobile terminal 10 as well as the type of information supplied by the application server 26 to the mobile terminal 10 for each of the more information buttons illustrated on the more detailed information screen 244 in FIG. 9.

FIG. 10A illustrates a listing agent screen 266 that is displayed on the display 50 as a result of the User hitting the “LISTING AGENT” button 246 illustrated in FIG. 9. When the user hits the “LISTING AGENT” button 246, a request is made from the mobile terminal 10 to the application server 26 to provide more detailed information about the listing agent, and the application server 26 will change the mobile terminal's 10 state to the “Listing Agent” state 140, as illustrated in FIG. 5B. The listing agent screen 266 comprises the listing agent's name 268, the phone number to make an appointment with the listing agent 270, the listing office of the listing agent 272, the office name of the listing agent 274, and the phone number 276 of the office indicated in the office name 274. The only option the User has on the mobile terminal 10 after the listing agent screen 266 is displayed is to hit the “BACK” button 278 to go back to the more detailed information state 135 illustrated in FIG. 5B, which will in turn cause the mobile terminal 10 to display the more detailed information screen 244 illustrated in FIG. 9.

FIG. 10B illustrates the location details screen 280 that is displayed by the mobile terminal 10 as a result of the user hitting the “LOCATION DETAILS” button 248 in FIG. 9. If the user presses this button, the mobile terminal 10 will initiate a communication with the application server 26 in which the application server 26 will change the mobile terminal's 10 state to the “Location Details” state 142, as illustrated in FIG. 5B. The application server 26 enters from the “More Detailed Information” state 135 to the “Location Details” sub-state 142 in FIG. 5B, and the application server 26 obtains the location details of the house listing selected by the user. The location details screen 280 contains several pieces of information relating to the house listing whose address is listed at the house address 282 on the display 50. The city of the house and the zip code of the house are displayed on the display 50, at the house location 284 and the zip code location 286. The subdivision in which the house address 282 is located is displayed in the subdivision name location 288. The area number of the house is displayed in the area location 290. The county in which the house is located is displayed in the county location 292. Lastly, if any directions are available from the application server 26, directions to the house are displayed in the directions location 294.

The user has two options after the location details are displayed on the location details screen 280 on the mobile terminal 10 display 50. The user can either hit the “BACK” button 296 to go back to the “More Detailed Information” state 135 in FIG. 5B in which the more detailed information screen 244 is displayed, as illustrated in FIG. 9. Or, the user may initiate a new search for other houses that are listed in the same subdivision as the house selected by the user for location details by hitting the more houses in “SUBDIVISION” button 298. If the user hits the more houses in “SUBDIVISON” button 298, the application server 26 will move the mobile terminal 10 from the “Location Details” state 142 in FIG. 5B to the “List of Matching Houses” state 132 in FIG. 5A in which the application server 26 will perform a new search and will communicate the results of such search to the mobile terminal 10 just as the application server 26 would perform if the mobile terminal 10 was moving from the “Query” state 130 to the “List of Matching Houses” state 132 in FIG. 5A.

FIG. 10C illustrates an interior details screen 300 that is displayed by the mobile terminal 10 as a result of the user hitting the “INTERIOR DETAILS” button 250 in FIG. 9. If the user presses this button, the mobile terminal 10 will initiate a communication with the application server 26 in which the application server 26 will change the mobile terminal's 10 state to the “Interior Details” state 144, as illustrated in FIG. 5B. The application server 26 will obtain the interior details regarding the house listing selected by the user as communicated by the mobile terminal 10 and will return the information about the interior details via a communication from the application server 26 to the mobile terminal 10. The application server 26 will move the mobile terminal 10 from the “More Detailed Information” state 135 to the “Interior Details” state 144 as illustrated in FIG. 5B. The interior details information will then be displayed on the display 50 on the interior detail screen 300.

The information that is displayed on the interior detail screen 300, as illustrated in FIG. 10C, includes the number of full baths in the number of full baths location 302, and the number of half-bathrooms in the number of half-bathrooms location 304. The number of bedrooms is displayed in the number of bedrooms location 305. The location of the master bedroom is indicated in the location of master bedroom location 306. The total number of rooms for the house listing is located in the total number of rooms location 308. If the house listing includes a fireplace, the type of fireplace is listed in the type of fireplace location 310. Additionally, the number of heated, unheated, and basement square footage of the house listing is displayed in the heated square foot location 312, the unheated square foot location 314, and the basement square footage location 316. If the house listing does not include a basement, the word “no” is listed in the basement square footage location 316. The only option that the user has after the interior detail screen 300 is displayed on the display 50 is to hit the “BACK” button 318, which will cause the mobile terminal 10 to initiate a communication with the application server 126 to move from the “Interior Details” state 144 to the “More Detailed Information” state 135 as illustrated in FIG. 5B.

FIG. 10D illustrates the exterior details screen 320 that is displayed by the mobile terminal 10 in response to the user pressing the “EXTERIOR DETAILS” button 252 on the more detailed information screen 244 illustrated in FIG. 9. If the user presses this button, the mobile terminal 10 will initiate a communication with the application server 26 in which the application server 26 will change the mobile terminal's 10 state to the “Exterior Details” state 146, as illustrated in FIG. 5B. The exterior details screen 320 operates like the interior details screen 300 illustrated in FIG. 10C. The exterior details screen 320 displays the number of garages in the number of garages location 322 for the house listing selected. The year in which the house listing selected was built is displayed in the year built location 324. The type of foundation is displayed in the type of foundation field 326. The type of roof, type of siding, style of house, and the type of the house are displayed in the type of roof location 328, type of siding location 330, style of house location 332, and the type of the house location 334, respectively. Lastly, more information about the exterior of the house is listed in the exterior details location 336. The user can go back to the “More Detailed Information” state 135 by pressing the “BACK” button 338 at which point the user will be returned to the more detailed information screen 244, as illustrated in FIG. 9. The application server 26 will change the mobile terminal's 10 state from the “Exterior Details” state 146 to the “More Detailed Information” state 135 as illustrated in FIG. 5B.

FIG. 10E illustrates the lot details screen 340 that is displayed by the mobile terminal 10 in response to the user pressing the “LOT DETAILS” button 254 in FIG. 9. If the user presses this button, the mobile terminal 10 will initiate a communication with the application server 26 in which the application server 26 will change the mobile terminal's 10 state to the “Lot Details” state 148, as illustrated in FIG. 5B. The information displayed on the display 50 for the lot details includes the acreage of the listing in the acreage location 342, the lot dimensions in the lot dimension location 344, the lot number in the lot number location 346, and the lot description in the lot description location 348. Again, the user can hit the “BACK” button 350 to return to the “More Detailed Information” state 135 where the more detailed information screen 244 is displayed by the mobile terminal 10 as illustrated in FIG. 9. Once the user presses the “BACK” button 350, the application server 26 moves the mobile terminal's 10 state from the “Lot Details” state 148 to the “More Detailed Information” state 135 as illustrated in FIG. 5B.

If the user desires more detailed information about public schools that are restricted to the house listing selected, the user can hit the “SCHOOLS” button 256 in the more detailed information screen 244 illustrated in FIG. 9. If the user presses this button, the mobile terminal 10 will initiate a communication with the application server 26 in which the application server 26 will change the mobile terminal's 10 state to the “School” state 150, as illustrated in FIG. 5B. The application server 25 will return more detailed information about the schools restricted to the house listing selected to the mobile terminal 10 for display on the display 50. The mobile terminal 10 will display this information on the school information screen 352 as illustrated in FIG. 10F. The mobile terminal 10 will display the elementary school, the junior high school, and the high school public schools restricted to the house listing in the elementary school location 354, the junior high school location 356, and the high school location 358, respectively. Once the user hits the “BACK” button 360, the application server 26 will move the mobile terminal's 10 state from the “School” state 150 back to the “More Detailed Information” state 135, and the mobile terminal 10 will display the more detailed information screen 244, as illustrated in FIG. 9.

FIGS. 10G-1, 10G-2, and 10G-3 illustrate pictures that are displayed at the house listing if the user selects the pictures button 258 on the more detailed information screen 244 illustrated in FIG. 9. When the user hits the pictures button 258, the mobile terminal 10 will initiate a communication to the application server 26 to retrieve the pictures related to the house listing selected, and the application server 26 will change the mobile terminal's 10 state to the “Pictures” state 152, as illustrated in FIG. 5B. The application server 26 will then communicate picture data back to the mobile terminal 10 to be displayed on the display 50. Note that in FIG. 10G-1, a picture screen 362A includes a picture number menu 364 since the application server 26 is capable of returning more than one picture to the mobile terminal 10 to be displayed for a house listing. The user can select any of the pictures on the picture number menu 364 to retrieve various pictures of the house listing. Alternative picture screens that relate to additional pictures selected on the picture menu 364 are illustrated in FIGS. 10G-2 and 10G-3 as picture screens 362B and 362C, respectively. This application later describes the process in which pictures are retrieved by the application server 26 for house listings and communicated to the mobile terminal 10 to be displayed on the display 50.

After the user is finished reviewing the pictures of the house listing selected on the picture screen 362 via the picture number menu 364, the user can select the “BACK” button 368. In response, the mobile terminal 10 will communicate a back communication to the application server 26 so that the application server 26 returns from the “Pictures” state 152 to the “More Detailed Information” state 135, as illustrated in FIG. 5B. The mobile terminal 10 will then display the more detailed information screen 244, as illustrated in FIG. 9.

The last sub-state of the “More Detailed Information” state 135 is the “Remarks” state 154 illustrated in FIG. 5B. The “Remarks” state 164 is entered into as a result of the user hitting the “REMARKS” button 260 illustrated in FIG. 9 on the more detailed information screen 244. When the user hits the “REMARKS” button 260, the mobile terminal 10 communicates to the application server 26 to retrieve the remarks screen (not shown) regarding the housing listing selected. The application server 26 will then transition from the “More Detailed Information” state 135 to the “Remarks” state 154 for the mobile terminal 10. The remarks screen will display any various remarks that have been entered by the listing agent about the house listing selected (hot illustrated). After the remarks have been reviewed by the user, the user may hit the “BACK” button, just as illustrated in the previous figures, to cause the application server 26 to move the state of the mobile terminal 10 back to the “More Detailed Information” state 135, wherein the mobile terminal 10 will display the more detailed information screen 244 as illustrated in FIG. 9.

Once the user has decided to stop reviewing more detailed information about a house listing selected on the more detailed information screen 244 illustrated in FIG. 9, the user can either go back to the listing results by hitting the “BACK TO LIST” button 262 or can initiate a new query by hitting the “NEW QUERY” button 264. If the user hits the “BACK TO LIST” button 262, the application program will move the mobile terminal 10 from the “More Detailed Information” state 135 to previous state where the mobile terminal 10 was on, which will be either the “List of Matching Houses” state 132, the “Next Ten Listings of Matching Houses” state 133, or the “Back Ten Listings of Matching Houses” state 136, as illustrated in FIG. 5A. The user can then select another house listing for reviewing more detailed information, or the user can go to subsequent listings of houses found under the initial query search that are beyond the first ten, as illustrated in FIG. 7, by the user pressing the “NEXT” button 216. If the user hits the “NEW QUERY” button 264, the application program will move the mobile terminal 10 to the query state 130, as illustrated in FIG. 5A.

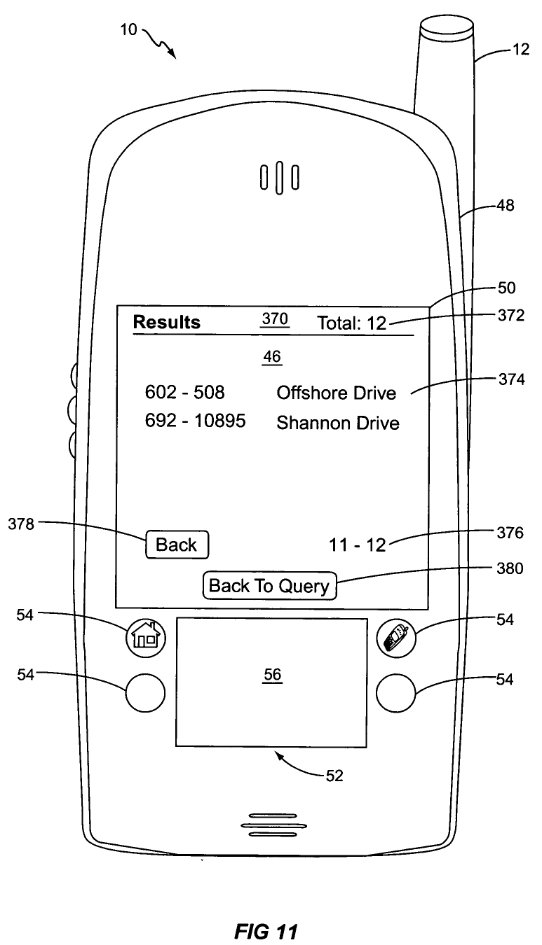

If the user presses the “NEXT” button 216 in FIG. 7 for the list of matching houses screen 206, the application server 26 will change the mobile terminal's state from the “List of Matching Houses” state 132 to the “Next Ten Listings of Matching Houses” state 133. The mobile terminal 10 will also display an additional list of matching houses screen 370 illustrated in FIG. 11. In this particular example, there were twelve house listings found, and only two house listings beyond the initial listing of ten houses illustrated in FIG. 7. Therefore, only the last two houses, eleven and twelve, are displayed in the results listing 374 on the display 50. Again, the total number of houses in the search results is listed in the total number of houses found location 372.

The current results listing range being displayed on the display 50 is contained in the results listing range location 376. The user can then hit the “BACK” button 378 to go from the “Next Ten Listing of Matching House” states 132 to the “Back to Ten Listing of Matching Houses” state 136 as illustrated in FIG. 5A. If a house is selected from one of the additional listings illustrated in FIG. 11, the application server 26 will transition from the “Next Ten List of Matching Houses” state 133 to the “More Detailed Information” state 135. So long as the user continues to traverse the resulting list 210 back and forth as illustrated in FIGS. 7 and 11, the application server 26 will continue to move back and forth between the “Back Ten Listing of Matching Houses” state 136 and the “Next Ten List of Matching Houses” state 133.

If the more detailed information about a house listing is selected from either of these two previous states, the application server will move to the “More Detailed Information” state 135 as illustrated in FIG. 5B. The user may determine to quit and to disconnect communications to the application server 26 from any of the states and any of the screens previously described. In this case, as illustrated in FIG. 5A, the user indicating a quit on the mobile terminal 10 will cause the mobile terminal 10 to disconnect communications with the application server 26 as illustrated by the disconnect box 138 in FIG. 5A. The remainder of this application focuses on additional features that are present in the application program resident in the mobile terminal 10 application server application program in program store 36 to perform additional functionalities.

Changing a Password For a User Name

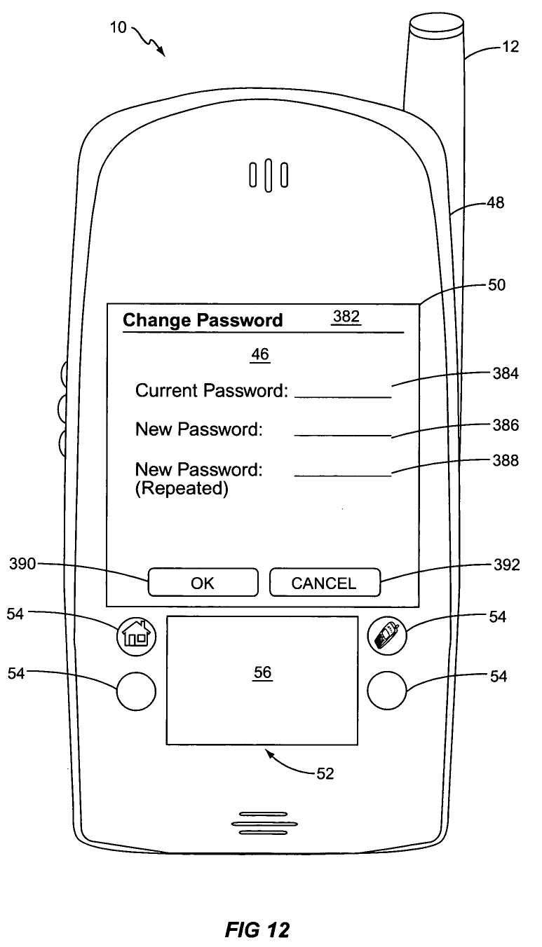

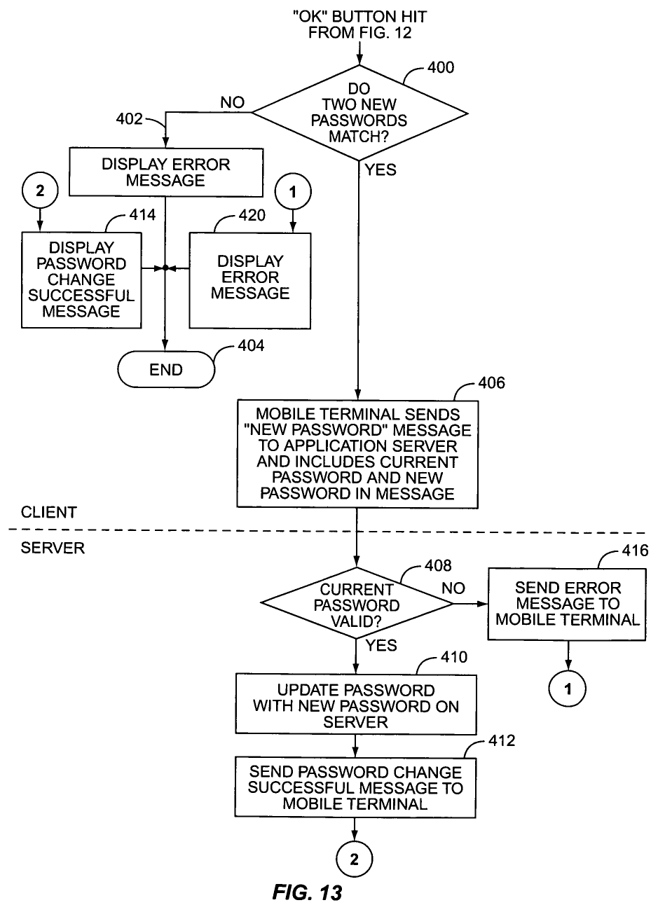

FIG. 12 illustrates how a user changes his or her password on the mobile terminal 10. As previously discussed, a password is required for a user name in order to successfully establish a communication between the mobile terminal 10 and the application server 26. The application server 26 will only establish a connection and allow the user, via the mobile terminal 10, to make house search queries and other information requests if the application server 26 recognizes the user name and password as being validated. For example, the user of a mobile terminal 10 may have to pay a subscription fee or other consideration to the owner of the application server 26 in order to gain access to the application server 26 via a valid user name and corresponding password.

FIG. 12 illustrates a change password screen 382 that a user can access on the mobile terminal 10 to change his or her password. The mobile terminal 10, in response to a request by the user to change his or her password, will display three fields for the user to fill in. The first field is the current password field 384. The user will enter his or her current password in the current password field 384. The user then enters the new desired password in the new password field 386 and again repeats the desired new password in the new password repeated field 388. This is required as an additional safety feature to ensure that the user entered the correct new password since the new password entered in the new password fields 386 and 388 will be blocked from view. The user next hits the “OK” button 390 to initiate the change password process. The user can also hit the “CANCEL” button 392 to abort the change password process such that the current password will remain intact without being changed on the application server 26.

FIG. 13 illustrates a flow chart of the process that is performed on both the mobile terminal 10 and the application server 26 after the user presses the “OK” button 390 on FIG. 12. First, the mobile terminal 10 verifies that the two new passwords entered in the new password field 386 and 388 match (decision 400). If they do not, an error message is displayed on the display 50 of the mobile terminal 10 (block 402) and the process ends (block 404). If the two new passwords entered in the new password fields 386 and 388 match in decision 400, the mobile terminal 10 sends a new password message to the application server 26 and includes as information in the message the current password and the new password (block 406).

The application server 26 receives the new password request message and the current and new password (only one copy) from the mobile terminal 10. The application server 26 then determines if the current password is valid (decision 408). If the current password is not valid, the user is not allowed to change the password to the new password since the user did not know or entered incorrectly the current password. In response, the application server will send an error message to the mobile terminal 10 (block 416), which Will in turn cause the mobile terminal 10 to display an error message on the display 50 (block 420), and the process will end without the user password having been changed (block 404).

If the current password was validated in decision 408, the application server 26 updates the password for the user name with the new password on the application server data store 38 (block 410). The application server 26 will then send a message to the mobile terminal 10 that the password change has been successfully made (block 412) and the mobile terminal 10 will display to the user that the password has been successfully changed on the display 50 (block 414), and the process will end (block 404).

Redundant Application Servers and Information Server

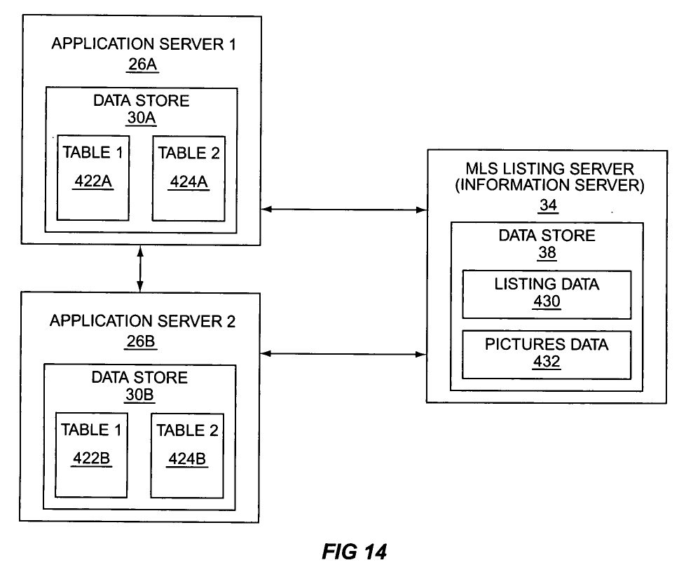

FIG. 14 illustrates a redundant application server 26 architecture that may be used in the present invention wherein each of the redundant application servers 26 are coupled to a MLS listing server 34, which acts as the information server 34. As previously illustrated in FIG. 1, the communication links between the application server one 26A, application server two 26B, and the communication links between those two servers 26A, 26B and the MLS listing server 34 are via the data packet network 21 in FIG. 1 over the Internet 24. The application servers one and two 26A, 26B both contain duplicate images of data store 30. In each application server 26A, 26B, two tables are provided for the MLS house listings that are downloaded from the MLS listing server 34, discussed later below. Application server one 26A contains two tables 422A, 424A, and application server two 26B contains two tables, table one 422B and table two 424B. The MLS listing server 34 has the house listing data 430 and pictures data 432 store in its listing data 430 and pictures data 432 as part of its data store 38. The house listing data 430 comprises textual information regarding house listings. Pictures data 432 contain pictures of the houses that correlate to the house listing data 430. The reason that the application servers one and two 26A, 26B contain two tables in data store 30A, 30B is so that a mobile terminal 10 may continue to access the application server 26 and its house listings from data store 30A, 30B when the application servers 26A, 26B are updating their data store 30A, 30B with the listings data 430 and pictures data data 432 from the MLS listing server 34. Only one table 422A or 424A, or 422B or 424B in each application server 26A, 26B is updated at a time, so that the other table not being updated is available for access by mobile terminals 10.

Password Updating

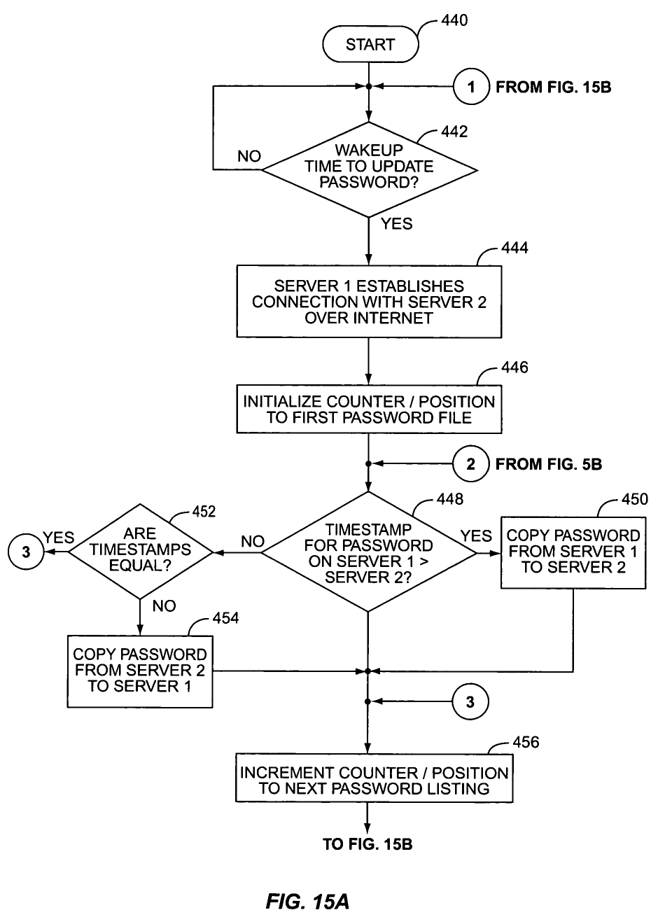

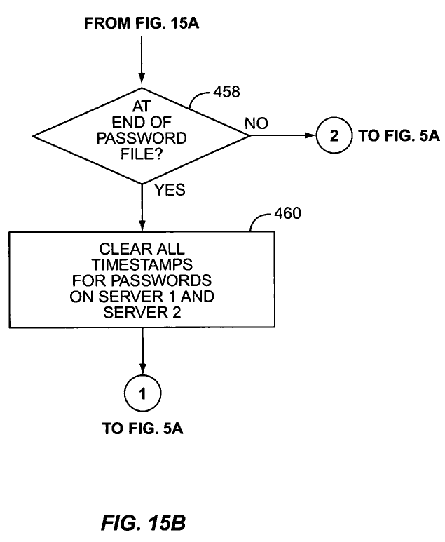

Application server one 26A and application server two 26B also contain other information besides house listings in data store 30A, 30B. For instance, the user names and passwords for mobile terminals 10 that are allowed to access the application server's 26 data are also stored in data store 30A. Typically, application server two 26B is not accessed by a mobile terminal 10 unless application server one 26A is Unavailable, as previously described above for FIGS. 4A and 4B. If a user changes his or her password, as previously described, the password change will only take effect in the application server 26 to which the mobile terminal 10 is connected. Due to this, it is necessary that application server one 26A and application server two 26B periodically establish communications with each other to update each other's password files with the latest passwords for user names of mobile terminals 10 that are allowed to establish communications with the application servers 26. FIGS. 15A and 15B illustrate this process.

Turning to FIGS. 15A and 15B, the process starts (block 440) and application server one 26A determines if it is time to establish communications with application server to 26B to update their perspective password files (decision 442). Note that in this example, application server one 26A always establishes communication with application server two 26B such that application server one 26A is the master and application server two 26B is the slave. The reverse could also be implemented.

If it is not time for the application server one 26A to establish the connection with application server two 26B to reconcile password files, the process continues to repeat by continuing to return to decision 442. Decision 442 may be based on a timer, interrupts or other methods of periodically performing tasks in a microprocessor based computer system and may be based on a relative or absolute time. If it is time for the password files to be updated between application server one 26A and application server two 26B, application server one 26A establishes the initial communication connection with application server two 268 over the Internet 24 (block 444). Next, the application server one 26A initializes a counter or position in the password file or data store 30A that contains the passwords so that each of the passwords correlating to the same user names stored in application server one 26A and application server two 26B can be compared to each other (block 446).

Application server one 26A determines if a password for a given user name in data store 30A in application server one 26A was updated later than the corresponding password in data store 30B on application server two 26B (decision 448). If the answer is yes, such password stored in application server one 26A is copied to application server two 26B so that the passwords match for such user name (block 450) and the application server 26 then moves to the next password to compare (block 456). If the answer in decision 448 is no, meaning that the password on application server one 26A was not updated later than a corresponding password on application server two 26B, application server one 26A determines if the time stamps for such passwords are equal (decision 452). If not, this means that the password stored on application server two 26B was updated later than the corresponding password on application server one 26A. In this case, application server one 26A causes the password in application server two 26B to be copied to the corresponding password in application server one 26A (block 454) and the process continues to block 456 as previously described above. If the time stamps or the passwords were equal in decision 452 for corresponding passwords on application server one 26A and application server two 26B, the process jumps to block 456 as well without any updating since the passwords match.

Next, application server one 26A determines if all passwords have been compared for each user name stored in data store 30A (decision 458). If not, the process returns back to decision 448 to perform the same comparison on the next password stored in the data store 30A of application server one 26A and data store 30B of the application server two 26B. If all passwords have been compared, checked and updated in decision 458, application server one 26A clears all timestamps for passwords in application data store 30A and instructs application server two 26B to clear all timestamps for passwords in data store 30B (block 360) and the process returns back to decision 442 in FIG. 15A to wait for the next time to update passwords.

Downloading Of Information From Information Server To Application Server

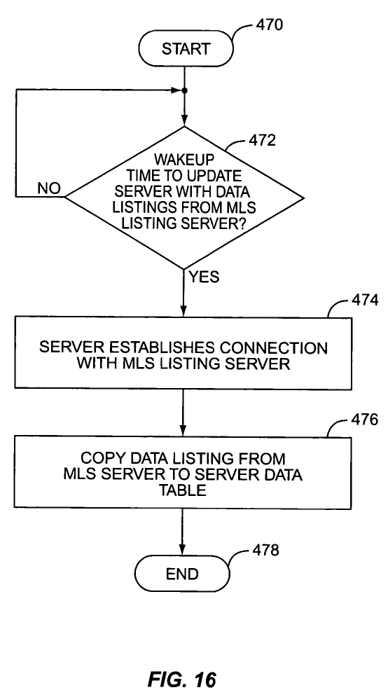

FIG. 16 illustrates how listing data 430 on the MLS listing server 34 is downloaded to each of the application servers 26A, 26B. It may be desired to provide redundant application servers 26A, 26B to contains redundant copies of MLS house listings and related picture data so that the mobile terminal 10 can connect to one application server 26 if the other application server 26 is unavailable. Each application server 26A, 26B executes its own program from program store 28 to independently download listing data 430 and pictures data 432 from the MLS listing server 134. The flowchart illustrated in FIG. 16 is executed by both the application server one 26A and application server two 26B.

The process starts (block 470) and the application server 26 determines if it is an appropriate time to update its house listings With the listing data 430 and pictures data 432 from the MLS listing server 34 (decision 472). Again, this wakeup may be an interrupt, a timer, or other mechanism to periodically run this particular process just like that for the process in FIG. 15 for updating passwords. If it is not time for the application server 26 to update its listing information with listing data 430 and pictures data 432, the process continues to repeat by returning to decision 472.

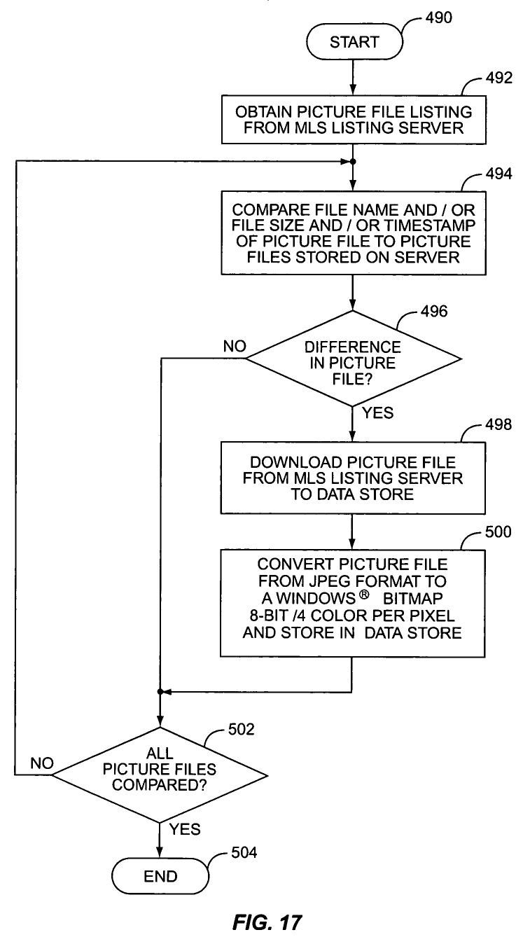

If it is time for the application server 26 to update its listing information with listing data 430 and pictures data 432 from the MLS listing server 34 in decision 472, the application server 26 establishes a connection over the Internet 24 with the MLS listing server 34 (block 474). Subsequently, the application server 26 downloads from the MLS listing server 34, the listing data 430 and pictures data 432 from the MLS listing server 34 to the data store 30 of the application server 26. All data from the listing data 430 and the information from the listing server 34 is downloaded regardless of whether such data has changed from that stored already in the data store 30 of the application server 26. However, all pictures data 432 are not downloaded unless there has been an update or the addition of a new picture on the MLS listing server 34 from that stored in data store 30 of the application server 26. FIG. 17 illustrates this process.

The process starts (block 490) and the application server 26 executes a command to obtain a picture file listing from the MLS listing server 34 (block 492). This is because the pictures data 432 stored on the MLS listing server 34 are stored in separate files for each corresponding listing data 430 and the application server 26 is capable of determining which listing data 430 contains corresponding pictures data 432 on the MLS listing server 34. Some listing data 430 may not contain a corresponding picture in the pictures data 432.

Continuing on, the application server 26 compares the file name and/or file size and/or timestamp of the picture file in the pictures data 432 to the corresponding picture file stored previously on the application server 26 (block 494). If there is any difference in the picture file in that it is different in any manner as previously discussed for block 494, or if the picture file is one that exists in the pictures data 432, but has not been previously stored in any previous version in the data store 30 of application server 26 (decision 496), the application server 26 downloads the picture file from the MLS listing server 34 to the data store 30 of the application server 26 in both table one and table two for the application server 26 (block 498). The application server 26 then converts the picture file from a JPEG format to a Windows ® bitmap in 8-bit /4 colors per pixel, and the picture file is stored in data store 30 on the application server 26 (block 500). In this particular example, the reason for the conversion from JPEG format to a Windows® bitmap is to reduce the size of the picture to conserve memory in the data store 30, and because a higher resolution JPEG format is not required to give an acceptable display of the picture on the mobile terminal 10 display 50.

Next, after either the picture file 432 is converted before being stored in the data store 30 in block 500, or if there was no difference in a picture file between one stored in the pictures data 432 and the corresponding picture file stored in the data store 30 in decision 496, the application server 26 determines if all picture files have been compared that are present in the pictures data 432 on the MLS listing server 34. If not, the process repeats by returning back to block 494 for the subsequent picture file. If yes, the process ends (block 504) until the next pictures file 432 update is performed. The process in FIG. 17 may also be performed as a subset of block 476 in FIG. 16, previously described above.

The pictures files 432 downloaded from the MLS listing 34 that are stored in data store 30 on the application server 26 are stored resident in a Windows®) bitmap form. However, the application server 26 may need to further convert such picture file to a different format depending on the type of mobile terminal 10 to Which the picture file is to be communicated. In one embodiment, the mobile terminal 10 is a Palm® personal computing device that is designed to display Palm® bitmaps. Therefore, any pictures data 432 that is communicated from the application server 26 to a PALM® based mobile terminal 10 must be in a Palm® bitmap form.

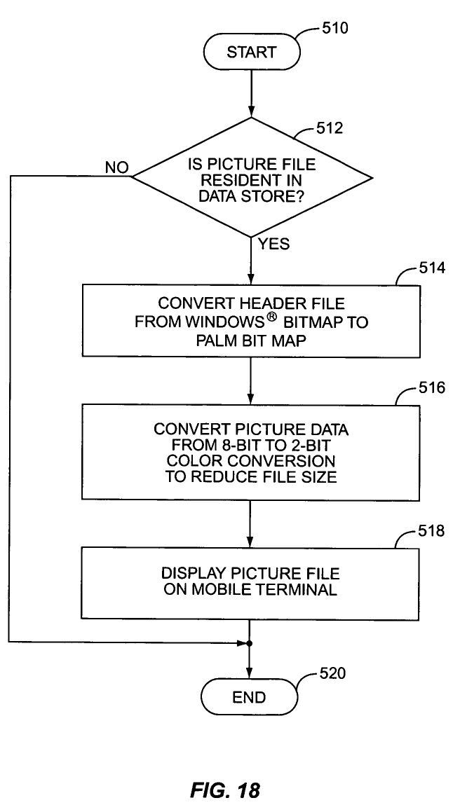

Turning now to FIG. 18, a flowchart illustrates the process performed by the application server 26 when the application server 26 communicates a picture file to the mobile terminal 10 in response to a query, as previously described. The process starts (block 510), and the application server determines if the picture file that corresponds to a listing query by a mobile terminal 10 is resident in data store 30 on the application server 26 (decision 512). If not, this means that there is no picture file that corresponds to house listing data is stored in data store 30 on the application server 26, and the process ends (block 520) with no picture file or information being communicated from the application server 26 to the mobile terminal 10.

If the answer to decision 512 is yes, meaning that there is a corresponding picture file to a queried house listing or search requested by the mobile terminal 10, the application server will convert the picture file from a Windows® bitmap to a Palm® bitmap in the particular example illustrated (block 514). This conversion may include converting Windows® bitmap header information, including but not limited to height, width, compression, version, pixel size, file type, file size, byte offset, bytes in header, number of colored planes, bits per pixel, image size, resolution, and number of color indexes, for example. Next, the application server 26 converts the picture file from an 8-bit to 2-bit color conversion to reduce the size of the picture file for faster communication between the application server 26 and the mobile terminal 10 (block 516). Last, the picture file is displayed on the display 50 of the mobile terminal 10 (block 518), and the process ends (block 520).

Those skilled in the art will recognize improvements and modifications to the preferred embodiments of the present invention. All such improvements and modifications are considered within the scope of the concepts disclosed herein and the claims that follow.

1. A system for communicating information contained in a call between a mobile terminal and a cellular telephone network, comprising:
an application server coupled to a data packet network and addressable using an IP address, wherein said application server comprises:
a program store; and
a data store,
said program store executes an application program containing a state-machine on said application server;
said application server adapted to receive a data packet from the cellular telephone network over said data packet network and establish a peer-to-peer-connection over said data packet network with the mobile terminal that initiated the call to the cellular telephone network in response to the call wherein said peer-to-peer connection remains open until the call is terminated;
said application program creates a unique thread for said connection and assigns a state in said state-machine to said thread, wherein said application server executes said application program for said thread based on said state, and wherein said application program communicates data in said data store over said data packet network destined for the mobile terminal based on said state of said thread.

2. The system of claim 1 wherein said data in said data store is real estate listing data.

3. The system of claim 1 wherein said application server is coupled to said data packet network by coupling to a packet access network which is coupled to said data packet network.

4. The system of claim 1 wherein said data packet network is a TCP/IP based data packet network.

5. The system of claim 1 wherein said application program sends a connection successful message over the data packet network destined for the mobile terminal after said connection is successfully made with said application server.

6. The system of claim 1 wherein said application program validates a user name and a password received from said data packet network and sends a password valid message if said password received matches the password in said data store associated with said user name.

7. The system of claim 1 wherein said application program comprises a query state that is entered for said connection after said connection is established with the mobile terminal.

8. The system of claim 7 wherein said application server receives search criteria from said data packet network when said connection is in said query state.

9. The system of claim 8 wherein said application server communicates listing information comprised of said information that matches said search criteria over said data packet network destined for the mobile terminal.

10. The system of claim 9, wherein said connection enters into a listing state after said listing information is communicated over said data packet network destined for the mobile terminal.

11. The system of claim 10 wherein said application server receives a more detailed information message regarding a listing selected from said listing information from said data packet network.

12. The system of claim 11 wherein said application server communicates more detailed information available regarding said listing over said data packet network destined for the mobile terminal.

13. The system of claim 12 wherein said more detailed information available is comprised from the group consisting of location details, interior details, exterior details, remarks, pictures, schools, lot details, and a listing agent.

14. The system of claim 12 wherein said connection enters into a more detailed information state after said more detailed information available is communicated over said data packet network destined for the mobile terminal.

15. The system of claim 14 wherein said application server receives a back to query message from said data packet network.

16. The system of claim 14 wherein said connection enters into said query state after said application server receives said back to query message from said data packet network.

17. The system of claim 14 wherein said application server receives a listing message from said data packet network.

18. The system of claim 17 wherein said connection enters into said listing state after said application server receives said listing message from said data packet network.

19. The system of claim 10 wherein said application server receives a next listing message from said data packet network.

20. The system of claim 19 wherein said application server communicates additional listing information comprised of said information that matches said search criteria over said data packet network destined for the mobile terminal.

21. The system of claim 20 wherein said connection enters into a next listing state after said additional listing information is communicated over said data packet network destined for the mobile terminal.

22. The system of claim 1 wherein said application server terminates said connection if said application server receives a quit message from said data packet network.

23. The system of claim 1 wherein said application server receives a new password message from said data packet network.

24. The system of claim 23 wherein said application program changes a password in said data store associated with a user name with a new password received from said new password message if said application program verifies that a current password in said new password message matches a password associated with said user name in said data store.

25. The system of claim 23 wherein said application program sends an error message over said data packet network destined for the mobile terminal if a current password in said new password message does not match a password associated With said user name in said data store.

26. The system of claim 1, further comprising:
a second application server coupled to a data packet network and addressable using an IP address, wherein said second application server comprises:
a program store; and
a data store,
said program store executes an application program containing a state-machine on said application server;
said second application server adapted to receive a data packet from the cellular telephone network over said data packet network and establish a peer-to-peer-connection over said data packet network with the mobile terminal that initiated the call to the cellular telephone network in response to the call wherein said peer-to-peer connection remains open until the call is terminated;
said application program assigns a thread to said connection and assigns a state in said state-machine to said thread, wherein said application server executes said application program for said thread based on said state, and wherein said application program communicates data in said data store over said data packet network destined for the mobile terminal based on said state of said thread.

27. The system of claim 26 wherein said application server establishes communication with said second application server over said data network packet.

28. The system of claim 27 wherein said establishment of said communication of said application server to said second application server is scheduled on said application server to occur on a periodic basis.

29. The system of claim 26 wherein said data store in said application server contains passwords associated with user names and said data store in said second application server contains passwords associated with said user names.

30. The system of claim 29 wherein said application program on said application server compares said password for said user name in said data store in said application server to said password for said user name in said data store in said second application server.

31. The system of claim 30 wherein said second application program stores said password for said user name in said data store in said application server associated with said user name if said password in said data store for said user name in said application server was updated later than said password in said data store for said second application server for said user name.

32. The system of claim 30 wherein said application program stores said password for said user name in said data store in said second application server associated With said user name if said password in said data store for said user name in said second application server was updated later than said password in said data store for said application server for said user name.

33. The system of claim 1 wherein said application server establishes a connection over said data packet network with an information server and downloads information from the information server received over said data packet network in said data store.

34. The system of claim 33, wherein said application server establishes said connection over said data packet network With said information server on a periodic basis.

35. The system of claim 33 wherein said application server obtains a listing of pictures files stored in said information server.

36. The system of claim 35 wherein said application server stores a picture file on said information server in said data store if said picture file is not already store in said data store.

37. The system of claim 35 wherein said application server stores a picture file on said information in said data store if said picture file has been updated after said picture file was stored in said data store.

38. The system of claim 35 wherein said application server converts said picture file from a JPEG format file into a Windows® bitmap.

39. The system of claim 35, wherein said application server establishes said connection over said data packet network with said information server on a periodic basis.

40. A communication system for requesting and delivering information to a mobile terminal, comprising:
a mobile terminal;
a cellular telephone network wherein said mobile terminal places a call to said cellular telephone network to communicate data to said cellular telephone network, wherein said cellular telephone network is coupled to a data packet network; and
an application server coupled to said data packet network and addressable using an IP address, wherein said application server comprises:
a program store; and
a data store,
said program store executes an application program containing a state-machine on said application server;
said cellular telephone network establishes a peer-to-peer-connection between said mobile terminal and said application server over said data packet network in response to said call wherein said peer-to-peer connection remains open until said call is terminated;
said application program assigns a thread to said connection and assigns a state in said state-machine to said thread, wherein said application server executes said application program for said thread based on said state, and wherein said application program communicates data in said data store to said mobile terminal based on said state of said thread.

41. The system of claim 40, further comprising:
a display; and
an input pad.

42. The system of claim 41 wherein said input pad is comprised from the group consisting of an input button and an input pad.

43. The system of claim 41 wherein said display is a touch screen display and said input pad is said touch screen display.

44. The system of claim 40 wherein said mobile terminal displays a connect screen on said display comprised of a user name field and a password field.

45. The system of claim 44, wherein said mobile terminal communicates a user name in said user name field and a password in said password file over said data packet network to establish said connection.

46. The system of claim 40, wherein said mobile terminal is adapted to display a configuration screen on said display to allow a user to enter a primary web address in a primary web address field to form said IP address.

47. The system of claim 46, wherein said configuration screen further comprises a secondary web address to form said IP address.

48. The system of claim 47 wherein said mobile terminal checks the validity of said primary web address by communicating a request to said cellular telephone network to validate said primary web address.

49. The system of claim 48 wherein said mobile terminal attempts to connect to an application server using said primary web address as said IP address if said cellular telephone network validated said primary web address.

50. The system of claim 49 wherein said mobile terminal checks the validity of said secondary web address if either said primary web address was validated by said cellular telephone network or said mobile terminal could not connect to an application server located at said primary web address.

51. The system of claim 40 wherein said mobile terminal displays a query screen on said display to allow a user to enter information in fields or boxes to create search criteria.

52. The system of 51 wherein said fields are comprised from the group consisting of a minimum price field, a maximum price field, a square footage field, a number of bedrooms field, a number of bathrooms field, a number of garages field, a type of house field, a house number field, a street field, a city code field, a zip code field, a subdivision field, an area field, a MLS field, a acres field, and a year built field.

53. The system of claim 51 wherein said boxes are comprised from the group consisting of a first floor master bedroom box, a basement box, and a only my listings box.

54. The system of claim 51 wherein said query screen further comprises a query button wherein said mobile terminal sends said search criteria to said application server when a user selects said query button.

55. The system of claim 40 wherein said mobile terminal displays a listing of matching houses screen on said display to display a listing of houses received from said application server over data packet network.

56. The system of 55 wherein said listing of matching houses screen is comprised from the group consisting of a total number of houses found location, a results listing location, a results listing range location, a back button, a next button and a back to query button.

57. The system of claim 55 wherein said mobile terminal displays a general information screen on said display to display general information received from said application server over data packet network about a house selected by the user from said listing of houses.

58. The system of claim 57 wherein said general information screen is comprised from the group consisting of a house street location, a heated square feet location, a price location, a number of bedrooms location, a number of bathrooms location, a listing agent location, a MLS number location, a more information button and a back to list button.

59. The system of claim 55 wherein said mobile terminal displays a more detailed information screen on said display to display more detailed information received from said application server over data packet network about a house selected by the user from said listing of houses.

60. The system of claim 59 wherein said general information screen is comprised from the group consisting of a listing agent button, a location details button, an interior details button, an exterior details button, a lot details button, a schools button, a pictures button, a remarks button, a back to list button, and a new query button.

61. The system of claim 40 wherein said mobile terminal displays a change password screen on said display.

62. The system of 61 wherein said change password screen is comprised from the group consisting of a current password field, a new password field, and a new password repeated field, an ok button, and a cancel button.

63. The system of claim 61 wherein said mobile terminal compares a new password entered by a user in a new password field with a new password repeated entered by a user in a new password repeated field wherein said mobile terminal communicates said new password to said application server if said new password and said new password repeated matches.

64. The system of claim 40 wherein said mobile terminal receives a picture file from said application server and converts said picture file to a PALM® bitmap.

65. The system of claim 64 wherein said picture file is converted from 8-bit color to 2-bit grey scale to reduce the size of said picture file.

66. A method for communicating information in a call between a mobile terminal and a cellular telephone network, comprising the steps of:
receiving a data packet at an application server from the cellular telephone network over a data packet network;
establishing a peer-to-peer connection between said application server and the mobile network that initiates the call over said data packet network;
keeping said connection open at said application server until the call is terminated;
executing an application program on said application server for said connection;
assigning a state in a state-machine executed by said application program to said connection; and
communicating data from a data store in said application server to the mobile terminal over said data packet network based on said state of said connection.

67. The method of claim 66, further comprising sending a connection successful message over said data packet network destined for the mobile terminal after said connection is successfully made with said application server.

68. The method of claim 66, further comprising:
validating a user name and a password received from said data packet network;
sending a password valid message to the mobile terminal over said data packet network if said password received matches the password in associated with said user name stored in said application server.

69. The method of claim 66, further comprising entering a query state for said connection after said connection is established with the mobile terminal.

70. The method of claim 69, further comprising receiving search criteria from said data packet network when said connection is in said query state.

71. The method of claim 70, further comprising communicating listing information comprised of said information that matches said search criteria over said data packet network destined for the mobile terminal.

72. The method of claim 71, further comprising entering into a listing state for said connection after said listing information is communicated over said data packet network destined for the mobile terminal.

73. The method of claim 72, further comprising receiving a more detailed information message regarding a listing selected from said listing information from said data packet network.

74. The method of claim 73, further comprising communicating more detailed information available regarding said listing over said data packet network destined for the mobile terminal.

75. The method of claim 74, further comprising entering into a more detailed information state for said connection after said more detailed information available is communicated over said data packet network destined for the mobile terminal.

76. The method of claim 75, further comprising receiving a back to query message from said data packet network.

77. The method of claim 75, further comprising entering into said query state for said connection after said application server receives said back to query message from said data packet network.

78. The method of claim 75, further comprising receiving a listing message from said data packet network.

79. The method of claim 78, further comprising entering into said listing state for said connection after said application server receives said listing message from said data packet network.

80. The method of claim 69, further comprising a next listing message from said data packet network.

81. The method of claim 80, further comprising communicating additional listing information comprised of said information that matches said search criteria over said data packet network destined for the mobile terminal.

82. The method of claim 81, further comprising entering into a next listing state for said connection after said additional listing information is communicated over said data packet network destined for the mobile terminal.

83. The method of claim 66, further comprising terminating said connection if said application server receives a quit message from said data packet network.

84. The method of claim 66, further comprising receiving a new password message from said data packet network.

85. The method of claim 84, further comprising changing a password in said data store associated with a user name with a new password received from said new password message if said application program verifies that a current password in said new password message matches a password associated with said user name in said data store.

86. The method of claim 84, further comprising sending an error message over said data packet network destined for the mobile terminal if a current password in said new password message does not match a password associated with said user name in said data store.

87. The method of claim 66, further comprising comparing said password for said user name in said data store in said application server to said password for said user name in said data store in a second application server.

88. The method of claim 87, further comprising storing said password for said user name in said data store in said application server associated with said user name if said password in said data store for said user name in said application server was updated later than said password in said data store for said second application server for said user name.

89. The method of claim 87, further comprising storing said password for said user name in said data store in said second application server associated with said user name if said password in said data store for said user name in said second application server was updated later than said password in said data store for said application server for said user name.

90. The method of claim 66, further comprising:
establishing a connection over said data packet network with an information server; and
downloading information from the information server received over said data packet network in said data store.

91. The method of claim 90, further comprising establishing said connection over said data packet network with said information server on a periodic basis.

92. The method of claim 90, further comprising obtaining a listing of pictures files stored in said information server.

93. The method of claim 92, further comprising storing a picture file on said information server in said data store if said picture file is not already store in said data store.

94. The method of claim 92, further comprising storing a picture file on said information in said data store if said picture file has been updated after said picture file was stored in said data store.

95. The method of claim 92, further comprising converting said picture file from a JPEG format file into a Windows® bitmap.

96. The method of claim 92, further comprising establishing said connection over said data packet network with said information server on a periodic basis.

97. A method of requesting and delivering information to a mobile terminal, comprising the steps of:
placing a call using a mobile terminal to a cellular telephone network to communicate data to said cellular telephone network, wherein said cellular telephone network is coupled to a data packet network; and
establishing a peer-to-peer-connection between said mobile terminal and a application server over a data packet network coupled to said application server and said cellular telephone network in response to said call;
assigning a thread on an application program for said connection;
assigning a state in a state-machine executed by said application program to said thread; and
executing an application program on said application server for said thread that is based on said state;
communicating data from a data store in said application server to the mobile terminal over said data packet network based on said state of said thread.

98. The method of claim 97, further comprising displaying a connect screen on a display associated with said mobile terminal that is comprised of a user name field and a password field.

99. The method of claim 98, further comprising communicating a user name in said user name field and a password in said password field over said data packet network to establish said connection.

100. The method of claim 97, further comprising displaying a configuration screen on a display associated with said mobile terminal to allow a user to enter a primary web address in a primary web address field to form a IP address for said application server.

101. The method of claim 100, further comprising displaying a second web address field to allow a user to enter a secondary web address on said configuration screen to form said IP address.

102. The method of claim 101, further comprising checking the validity of said primary web address by communicating a request to said cellular telephone network to validate said primary web address.

103. The method of claim 102, further comprising attempting to connect to said application server using said primary web address as said IP address if said cellular telephone network validated said primary web address.

104. The method of claim 103, further comprising checking the validity of said secondary web address if either said primary web address was validated by said cellular telephone network or said mobile terminal could not connect to an application server located at said primary web address.

105. The method of claim 97, further comprising displaying a query screen on a display associated with said mobile terminal to allow a user to enter information in fields or boxes to create search criteria.

106. The method of claim 105, further comprising sending said search criteria to said application server over said data packet network.

107. The method of claim 97, further comprising displaying a listing of matching houses screen on a display associate with said mobile terminal to display a listing of houses received from said application server over data packet network.

108. The method of claim 107, further comprising displaying a general information screen on said display to display general information received from said application server over data packet network about a house selected by the user from said listing of houses.

109. The method of claim 107, further comprising displaying a more detailed information screen on said display to display more detailed information received from said application server over data packet network about a house selected by the user from said listing of houses.

110. The method of claim 97, further comprising displaying a change password screen on a display associated with said mobile terminal.

111. The method of claim 110, further comprising comparing a new password entered by a user in a new password field with a new password repeated entered by a user in a new password repeated field wherein said mobile terminal communicates said new password to said application server if said new password and said new password repeated matches.

112. The method of claim 97, further comprising:
receiving picture file from said application server; and
converting said picture file to a PALM® bitmap.

113. The method of claim 112, further comprising converting said picture file from an 8-bit color to 2-bit grey scale to reduce the size of said picture file.
